(19) United States
(12) Patent Application Publication
(10) Pub. No.: US 2024/0256836 A1
(43) Pub. Date: Aug. 1, 2024

(54) TRAINING DEVICE, ESTIMATION SYSTEM, TRAINING METHOD, AND RECORDING MEDIUM

(71) Applicant: NEC Corporation, Minato- ku, Tokyo (JP)

(72) Inventors: Kenichiro FUKUSHI, Tokyo (JP); Chenhui HUANG, Tokyo (JP); Zhenwei WANG, Tokyo (JP); Fumiyuki NIHEY, Tokyo (JP); Hiroshi KAJITANI, Tokyo (JP); Kentaro NAKAHARA, Tokyo (JP)

(73) Assignee: NEC Corporation, Minato- ku, Tokyo (JP)

(21) Appl. No.: 18/570,463

(22) PCT Filed: Jun. 21, 2021
(86) PCT No.: PCT/JP2021/023436

§ 371 Date: Dec. 14, 2023

(51) Int. Cl. G06N 3/0455

(52) U.S. Cl. CPC G06N 3/0455

(57) ABSTRACT

A training device includes an acquisition unit that acquires a data set of raw data and correct answer data, a feature amount calculation unit that calculates a feature amount using the raw data, a model construction unit that constructs an encoding model that outputs a code related to the feature amount in response to an input of the raw data and an estimation model that outputs an estimation result related to the raw data in response to an input of the code, and a training processing unit that trains the encoding model and the estimation model in such a way that the estimation result matches the correct answer data based on a relationship between the code and the feature amount.

### TECHNICAL FIELD

The present disclosure relates to a training device or the like that constructs a model that perform estimation using data by machine training.

### BACKGROUND ART

With the spread of the Internet of Things (IoT) technology, various pieces of information about people and objects can be collected from various IoT devices. Attempts have been made to apply machine training to information collected by IoT devices and utilize the information in fields such as medical/healthcare and security. Classification accuracy of a model constructed by machine training can be analyzed using a general-purpose data set. For example, NPL 1 discloses a data set related to clothes and shoes. In an IoT device such as a sensor having a limited power supply capacity, for example, communication processing having larger power consumption than other processing is restricted. It is difficult for such an IoT device to transmit a large amount of data with high frequency.

PTL 1 discloses a data analysis system that reduces the dimension of observation data observed by an instrument to transmit low-dimension observation data to a device that analyzes the observation data. The instrument inputs observation data to an input layer of the trained neural network and performs processing up to a predetermined intermediate layer. The trained neural network is configured in such a way that the number of nodes in a predetermined intermediate layer is smaller than the number of nodes in an output layer. Under a predetermined constraint, the trained neural network is trained in advance in such a way that the overlapping of the probability distributions of the low-dimensional observation data for the observation data having different analysis results is reduced as compared with a case where there is no predetermined constraint. The instrument transmits a result processed up to a predetermined intermediate layer to the device as low-dimensional observation data. The instrument analyzes observation data observed by the instrument by inputting the received low-dimensional observation data to an intermediate layer next to a predetermined intermediate layer and performing the process.

### CITATION LIST

### Patent Literature

PTL 1: WO 2019/203232 A

### Non Patent Literature

NPL 1: H. Xiao, K. Rasul, R. Vollgraf, “Fashion-MNIST: a Novel Image Dataset for Benchmarking Machine Learning Algorithms”, arXiv preprint arXiv:1708.07747 (2017).

### SUMMARY OF INVENTION

### Technical Problem

In the method of PTL 1, low-dimensional observation data processed up to a predetermined intermediate layer is transmitted from the instrument to a device. Therefore, according to the method of PTL 1, the amount of data at the time of transmitting data from the instrument to the device can be reduced. However, the analysis using the dimensionally reduced data may cause a decrease in estimation accuracy.

A model trained by machine training as in PTL 1 can grasp a correlation between measurement data and correct answer data, but cannot grasp a causal relationship between measurement data and correct answer data. For example, in a case where a model that makes determination of hallux valgus using sensor data regarding the motion of the foot is trained by machine training, training different from the assumption may be performed. Since hallux valgus is common in women, a model trained by machine training may be trained to extract features of a woman's gait from sensor data. In other words, a model assumed to be constructed to make determination of hallux valgus may be trained to make determination of a female or not based on the sensor data. However, there is no causal relationship between hallux valgus and a female. Therefore, when the model trained in this way is applied to a male, the estimation accuracy regarding determination of hallux valgus may decrease.

An object of the present disclosure is to provide a training device and the like capable of constructing a model that performs highly accurate estimation while correctly grasping a causal relationship using a code obtained by reducing dimensions of raw data.

### Solution to Problem

A training device according to one aspect of the present disclosure includes an acquisition unit that acquires a data set of raw data and correct answer data, a feature amount calculation unit that calculates a feature amount using the raw data, a model construction unit that constructs an encoding model that outputs a code related to the feature amount in response to an input of the raw data and an estimation model that outputs an estimation result related to the raw data in response to an input of the code, and a training processing unit that trains the encoding model and the estimation model in such a way that the estimation result matches the correct answer data based on a relationship between the code and the feature amount.

In a training method executed by a computer according to an aspect of the present disclosure, the method includes acquiring a data set of raw data and correct answer data, calculating a feature amount using the raw data, constructing an encoding model that outputs a code related to the feature amount in response to an input of the raw data and an estimation model that outputs an estimation result related to the raw data in response to an input of the code, and training the encoding model and the estimation model in such a way that the estimation result matches the correct answer data based on a relationship between the code and the feature amount.

A program according to an aspect of the present disclosure causes a computer to execute a process of acquiring a data set of raw data and correct answer data, a process of calculating a feature amount using the raw data, a process of constructing an encoding model that outputs a code related to the feature amount in response to an input of the raw data and an estimation model that outputs an estimation result related to the raw data in response to an input of the code, and a process of training the encoding model and the estimation model in such a way that the estimation result matches the correct answer data based on a relationship between the code and the feature amount.

### Advantageous Effects of Invention

According to the present disclosure, it is possible to provide a training device and the like capable of constructing a model that performs highly accurate estimation while correctly grasping a causal relationship using a code obtained by reducing the dimension of raw data.

### BRIEF DESCRIPTION OF DRAWINGS

FIG. 1 is a block diagram illustrating an example of a configuration of a training device according to a first example embodiment.

FIG. 2 is a conceptual diagram for explaining an example of model training by a training processing unit of the training device according to the first example embodiment.

FIG. 3 is a flowchart for explaining an example of the operation of the training device according to the first example embodiment.

FIG. 4 is a flowchart for explaining an example of a training process by the training processing unit of the training device according to the first example embodiment.

FIG. 5 is a conceptual diagram for explaining another example of model training by the training processing unit of the training device according to the first example embodiment.

FIG. 6 is a block diagram illustrating an example of a configuration of a training device according to a second example embodiment.

FIG. 7 is a conceptual diagram for explaining an example of model training by a training processing unit of the training device according to the second example embodiment.

FIG. 8 is a flowchart for explaining an example of the operation of the training device according to the second example embodiment.

FIG. 9 is a flowchart for explaining an example of a training process by the training processing unit of the training device according to the second example embodiment.

FIG. 10 is a conceptual diagram for explaining another example of model training by the training processing unit of the training device according to the second example embodiment.

FIG. 11 is a block diagram illustrating an example of a configuration of a training device according to a third example embodiment.

FIG. 12 is a conceptual diagram for explaining an example of model training by a training processing unit of the training device according to the third example embodiment.

FIG. 13 is a flowchart for explaining an example of the operation of the training device according to the third example embodiment.

FIG. 14 is a flowchart for explaining an example of a training process by the training processing unit of the training device according to the third example embodiment.

FIG. 15 is a block diagram illustrating an example of a configuration of a training device according to a fourth example embodiment.

FIG. 16 is a block diagram illustrating an example of a configuration of an estimation system according to a fifth example embodiment.

FIG. 17 is a conceptual diagram illustrating an arrangement example of a measurement device of the estimation system according to the fifth example embodiment.

FIG. 18 is a block diagram illustrating an example of a configuration of the measurement device of the estimation system according to the fifth example embodiment.

FIG. 19 is a block diagram illustrating an example of a configuration of an estimation device of an estimation system according to the fifth example embodiment.

FIG. 20 is a conceptual diagram for explaining estimation by the estimation system and model update according to the fifth example embodiment.

FIG. 21 is a conceptual diagram illustrating an example in which an estimation result by the estimation system according to the fifth example embodiment is displayed on a screen of a mobile terminal.

FIG. 22 is a flowchart for explaining an example of the operation of the measurement device of the estimation system according to the fifth example embodiment.

FIG. 23 is a flowchart for explaining an example of the operation of an estimation device of the estimation system according to the fifth example embodiment.

FIG. 24 is a block diagram illustrating an example of a configuration of an estimation system according to a sixth example embodiment.

FIG. 25 is a block diagram illustrating an example of a configuration of a measurement device of the estimation system according to the sixth example embodiment.

FIG. 26 is a block diagram illustrating an example of a configuration of an estimation device of the estimation system according to the sixth example embodiment.

FIG. 27 is a conceptual diagram for explaining estimation by the estimation system and model update according to the sixth example embodiment.

FIG. 28 is a conceptual diagram illustrating an example in which an estimation result by the estimation system according to the sixth example embodiment is displayed on a screen of a mobile terminal.

FIG. 29 is a flowchart for explaining an example of the operation of the measurement device of the estimation system according to the sixth example embodiment.

FIG. 30 is a block diagram illustrating an example of a configuration of an estimation system according to a seventh example embodiment.

FIG. 31 is a block diagram illustrating an example of a configuration of a measurement device of the estimation system according to the seventh example embodiment.

FIG. 32 is a block diagram illustrating an example of a configuration of an estimation device of the estimation system according to the seventh example embodiment.

FIG. 33 is a conceptual diagram for explaining estimation by the estimation system and model update according to the seventh example embodiment.

FIG. 34 is a conceptual diagram illustrating an example in which an estimation result by the estimation system according to the seventh example embodiment is displayed on a screen of a mobile terminal.

FIG. 35 is a flowchart for explaining an example of the operation of the measurement device of the estimation system according to the seventh example embodiment.

FIG. 36 is a conceptual diagram for explaining a configuration and training of a model in a verification example.

FIG. 37 is a table summarizing details of a configuration of a model in the verification example.

FIG. 38 is a diagram for explaining a configuration of a model in a first comparative example.

FIG. 39 is a diagram for explaining a configuration of a model in a second comparative example.

FIG. 40 is a table summarizing classification accuracy and the like of the first verification example and the first and second comparative examples.

FIG. 41 is a diagram for explaining a relationship between a communication load and classification accuracy between the first verification example and the first and second comparative examples.

FIG. 42 is a table for explaining the reconstructed feature amount reconstructed by a reconstruction model of the first verification example.

FIG. 43 is a block diagram illustrating an example of a hardware configuration that achieves a training device and an estimation device according to each example embodiment.

### EXAMPLE EMBODIMENT

Hereinafter, embodiments of the present invention will be described with reference to the drawings. However, the example embodiments described below have technically preferable limitations for carrying out the present invention, but the scope of the present invention is not limited to the following. In all the drawings used in the following description of the example embodiment, the same reference numerals are given to the same parts unless there is a particular reason. In the following example embodiments, repeated description of similar configurations and operations may be omitted.

### First Example Embodiment

First, a training device according to a first example embodiment will be described with reference to the drawings. The training device of the present embodiment constructs a model that is trained with data collected by an Internet of Things (IoT) device and analyzes the data. For example, the training device of the present embodiment constructs a model that is trained with sensor data (raw data) related to a motion of a foot, and estimates a physical condition (estimation result). The method of the present embodiment can be applied to analysis of time-series data of sensor data, an image, and the like.

### (Configuration)

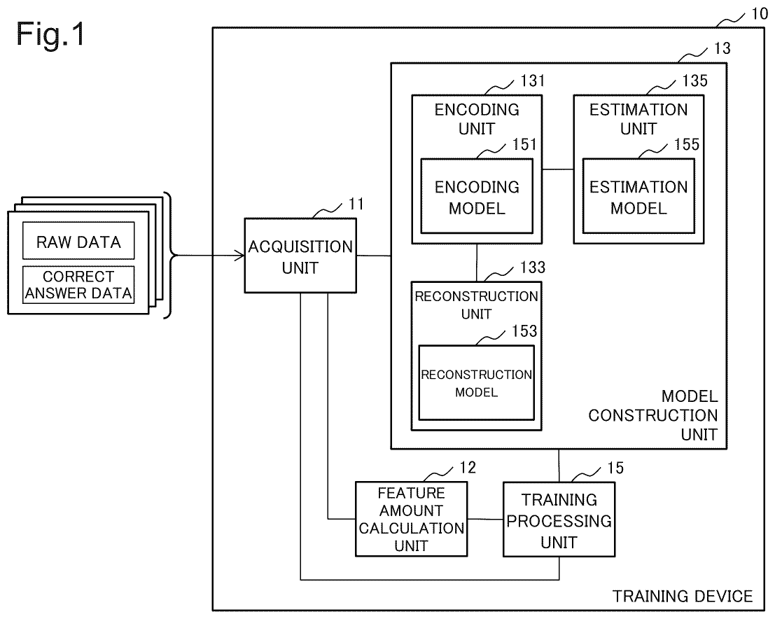

FIG. 1 is a block diagram illustrating an example of a configuration of a training device 10 according to the present embodiment. The training device 10 includes an acquisition unit 11, a feature amount calculation unit 12, a model construction unit 13, and a training processing unit 15.

The acquisition unit 11 acquires a plurality of data sets (also referred to as training data sets) used for model construction by the model construction unit 13. For example, the acquisition unit 11 acquires a training data set from a database (not illustrated) in which the training data set is accumulated. The training data set includes a data set obtained by combining raw data measured by the IoT device and correct answer data related to the raw data. The acquisition unit 11 acquires raw data and correct answer data in association with each other from a plurality of data sets included in the training data set.

The raw data may be subjected to some pre-processing. For example, the raw data may be subjected to pre-processing such as noise removal by a low-pass filter, a high-pass filter, or the like. For example, the raw data may be subjected to pre-processing such as outlier removal or missing value interpolation. For example, the raw data may be subjected to pre-processing such as frequency conversion, integration, and differentiation. For example, the raw data may be subjected to statistical processing such as averaging or distributed calculation as pre-processing. For example, when the raw data is time-series data, cutout of a predetermined section may be performed as pre-processing. For example, when the raw data is image data, cutout of a predetermined area may be performed as pre-processing. The pre-processing performed on the raw data is not limited to those listed here.

For example, the data set is information obtained by combining sensor data (raw data) related to the motion of the foot and a physical condition (correct answer data). For example, the sensor data includes sensor data such as an acceleration and an angular velocity. For example, the sensor data may include a speed, a position (trajectory), an angle, and the like obtained by integrating the acceleration and the angular velocity. For example, the physical condition includes a physical condition such as a degree of pronation/supination of the foot, a progress status of hallux valgus, and a possibility of falling down. The data set acquired by the acquisition unit 11 is not particularly limited as long as it is information obtained by combining the explanatory variable (raw data) and the objective variable (correct answer data).

The feature amount calculation unit 12 acquires raw data from the acquisition unit 11. The feature amount calculation unit 12 calculates a feature amount using the acquired raw data. In other words, the feature amount calculation unit 12 extracts a feature amount from the acquired raw data. For example, the feature amount calculation unit 12 calculates a feature amount that can be used for estimating the physical condition. For example, the feature amount calculation unit 12 calculates a feature amount that can be used to estimate the physical condition such as the degree of pronation/supination and the degree of progression of hallux valgus.

The model construction unit 13 acquires raw data from the acquisition unit 11. The model construction unit 13 includes an encoding unit 131, a reconstruction unit 133, and an estimation unit 135. The model construction unit 13 constructs a model group that outputs an estimation result using the raw data. For example, the model construction unit 13 constructs a machine training model (also referred to as a training model or a model) such as a deep neural network (DNN), a convolutional neural network (CNN), or a recurrent neural network (RNN). The model constructed by the model construction unit 13 is not limited to a DNN, a CNN, or an RNN. The model group constructed by the model construction unit 13 is trained by machine training by the training processing unit 15.

The encoding unit 131 includes an encoding model 151. The encoding unit 131 constructs the encoding model 151 that outputs a code in response to an input of raw data. The code includes a feature that enables estimation of correct answer data related to the raw data while the amount of data is reduced from the raw data. The number of dimensions of the code is set to be lower than that of the raw data. For example, the encoding unit 131 constructs the encoding model 151 that outputs a code in response to an input of raw data by unsupervised training

For example, the encoding model 151 outputs the time-series data (code) of 10 Hz in response to an input of the time-series data (raw data) measured at a cycle of 100 hertz (Hz). For example, the encoding model 151 outputs time-series data (code) whose amount of data has been reduced by averaging or noise removal in response to an input of time-series data corresponding to raw data. For example, the encoding model 151 outputs image data (code) of 7×7 pixels in response to an input of image data (raw data) of 28×28 pixels. The code is not limited with respect to the capacity or format of the data as long as the code has a smaller amount of data than the raw data and includes a feature that enables estimation of correct answer data related to the raw data.

The reconstruction unit 133 includes a reconstruction model 153. The reconstruction unit 133 constructs the reconstruction model 153 that outputs a reconstruction result (also referred to as a reconstructed feature amount) in response to an input of the code. The reconstructed feature amount is a feature amount of original raw data of a code reconstructed based on the code. For example, the reconstruction unit 133 constructs the reconstruction model 153 that outputs the reconstructed feature amount in response to an input of the code by supervised training using a data set of the code and the feature amount related to the code. The reconstructed feature amount includes a feature similar to the feature amount related to the reconstructed feature amount, but does not completely match the feature amount.

The estimation unit 135 includes an estimation model 155. The estimation unit 135 constructs the estimation model 155 that outputs the estimation result related to the original raw data of the code in response to an input of the code calculated by the encoding unit 131. For example, the estimation unit 135 constructs the estimation model 155 that outputs the estimation result in response to an input of the code by supervised training using a data set of the code and the correct answer data related to the original raw data of the code. For example, the estimation unit 135 may construct the estimation model 155 that outputs the estimation result in response to an input of the code or the feature amount by supervised training using a data set of the code or the feature amount and the correct answer data related to the original raw data of the code or the feature amount. For example, the estimation unit 135 may construct the estimation model 155 that outputs the estimation result in response to inputs of the code and the feature amount by supervised training using a data set of the code and the feature amount related to the code, and the correct answer data related to the code and the original raw data of the feature amount.

The training processing unit 15 trains the model group constructed in the model construction unit 13 by machine training. That is, the training processing unit 15 trains the encoding model 151, the reconstruction model 153, and the estimation model 155 constructed in the model construction unit 13 by machine training.

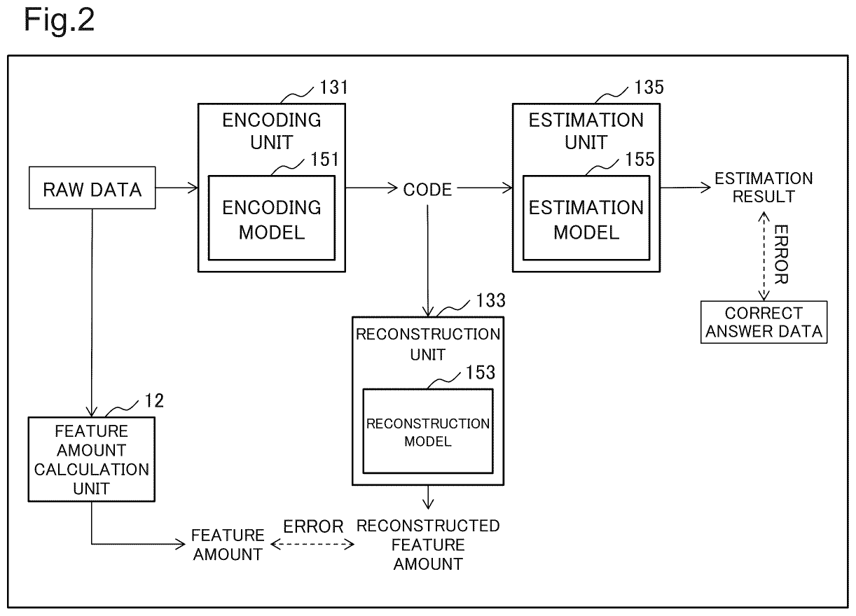

FIG. 2 is a conceptual diagram for explaining training of the encoding model 151, the reconstruction model 153, and the estimation model 155 by the training processing unit 15. In FIG. 2, the acquisition unit 11 and the training processing unit 15 are omitted.

The training processing unit 15 trains the encoding model 151 of the encoding unit 131 and the estimation model 155 of the estimation unit 135 in such a way that the estimation result of the estimation model 155 matches the correct answer data. That is, the training processing unit 15 optimizes the model parameters of the encoding model 151 and the estimation model 155 in such a way that the error between the estimation result of the estimation model 155 and the correct answer data is minimized.

The training processing unit 15 trains the encoding model 151 of the encoding unit 131 and the reconstruction model 153 of the reconstruction unit 133 in such a way that the reconstruction result (reconstructed feature amount) of the reconstruction model 153 matches the feature amount. That is, the training processing unit 15 optimizes the model parameters of the encoding model 151 and the reconstruction model 153 in such a way that the error between the reconstruction result (reconstructed feature amount) of the reconstruction model 153 and the feature amount is minimized.

In the present embodiment, the encoding model 151 is regularized by training the encoding model 151 and the reconstruction model 153 in such a way that an error between the reconstructed feature amount and the feature amount is minimized. As a result, it is possible to avoid deterioration of versatility due to erroneous over-training. For example, in a case where the progress status of hallux valgus, which is a symptom common to women, is estimated using sensor data regarding the motion of the foot, the feature amount included in the code may include more female features than hallux valgus features. In such a case, there is a possibility that the estimation model 155 that performs estimation of a female or not is constructed although the estimation model 155 that estimates the progress status of hallux valgus is intended to be constructed. According to the present embodiment, since erroneous over-training can be prevented by regularizing the encoding model 151, versatility and accuracy of the estimation model 155 are improved.

The model trained by the training processing unit 15 is implemented in an estimation system (not illustrated) that performs estimation based on raw data. For example, the estimation system includes a measurement device (not illustrated) that measures measurement data (raw data) and an estimation device (not illustrated) that performs estimation based on the measurement data. For example, the encoding model is implemented in the measurement device, and the estimation model is implemented in the estimation device. The measurement device encodes the measurement data using the encoding model to transmit the code to the estimation model. The estimation device inputs the code received from the measurement device to the estimation model to output an estimation result by the estimation model. Details of the estimation system using the model trained by the training processing unit 15 will be described later.

### (Operation)

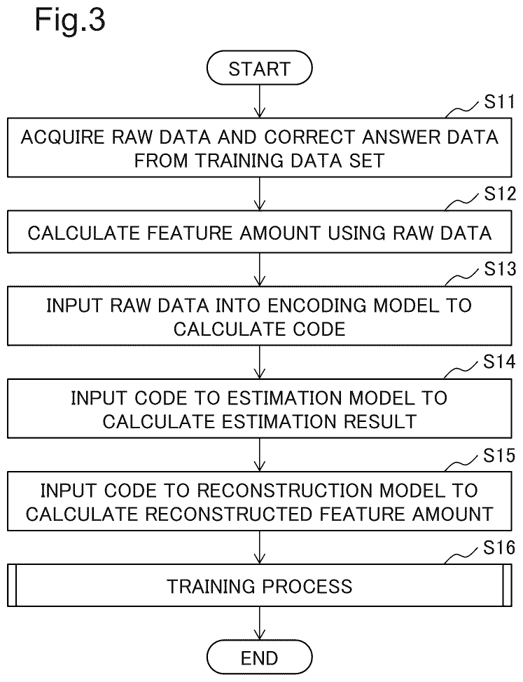

Next, the operation of the training device 10 of the present embodiment will be described with reference to the drawings. FIG. 3 is a flowchart for explaining an example of the operation of the training device 10. In the description along the flowchart of FIG. 3, the components of the training device 10 will be mainly described.

In FIG. 3, first, the acquisition unit 11 acquires raw data and correct answer data from the training data set (step S11).

Next, the feature amount calculation unit 12 calculates a feature amount using the raw data (step S12).

Next, the encoding unit 131 inputs the raw data to the encoding model 151 and calculates a code (step S13).

Next, the estimation unit 135 inputs the code to the estimation model 155 and calculates an estimation result (step S14).

Next, the reconstruction unit 133 inputs the code to the reconstruction model 153 and calculates a reconstruction result (reconstructed feature amount) (step S15). Steps S14 and S15 may be executed in a switched order, or may be executed in parallel.

Next, the training processing unit 15 executes a training process (step S16). Details of the training process will be described later. The model parameters of the model trained by the training processing unit 15 are set in an encoding model and an estimation model implemented in the estimation system (not illustrated).

### [Training Process]

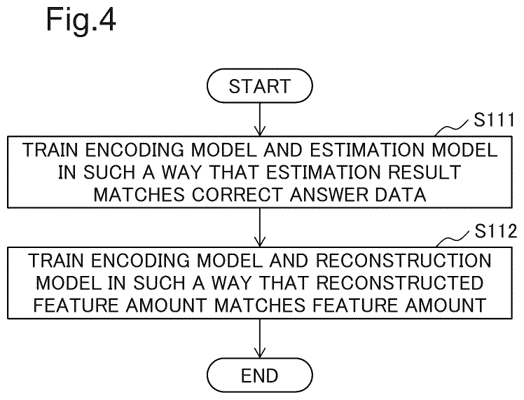

Next, the training process (step S16 in FIG. 3) by the training processing unit 15 will be described with reference to the drawings. FIG. 4 is a flowchart for explaining the training process by the training processing unit 15. In the processing along the flowchart of FIG. 4, the training processing unit 15 will be described as an operation subject.

In FIG. 4, first, the training processing unit 15 trains the encoding model 151 of the encoding unit 131 and the estimation model 155 of the estimation unit 135 in such a way that the estimation result using the estimation model 155 matches the correct answer data (step S111).

Next, the training processing unit 15 trains the encoding model 151 of the encoding unit 131 and the reconstruction model 153 of the reconstruction unit 133 in such a way that a reconstruction result (reconstructed feature amount) using the reconstruction model 153 matches the related feature amount (step S112). The model parameters of the model trained by the training processing unit 15 are set in an encoding model and an estimation model implemented in the estimation system (not illustrated).

### First Modification

Next, the first modification of the present embodiment will be described with reference to the drawings. In the present modification, the training processing unit 15 trains the estimation model 155 of the estimation unit 135 using the feature amount calculated by the feature amount calculation unit 12. The training processing unit 15 may be configured to train the estimation model 155 of the estimation unit 135 using the reconstructed feature amount output from the reconstruction model 153. The reconstructed feature amount and the feature amount have the same dimension. Even when the reconstructed feature amount is input to the estimation model 155 trained using the feature amount or the feature amount is input to the estimation model 155 trained using the reconstructed feature amount, an estimation result can be obtained.

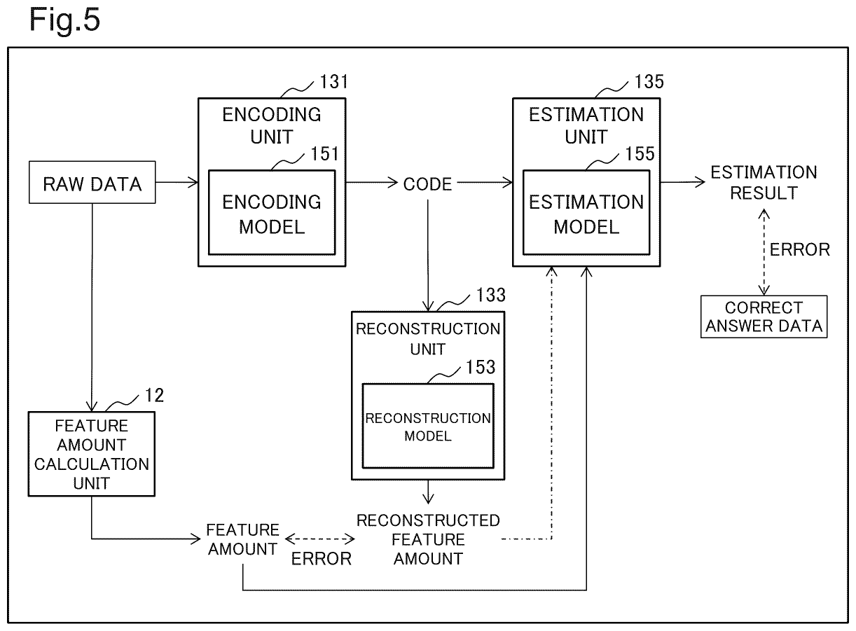

FIG. 5 is a conceptual diagram for explaining training of the encoding model 151, the reconstruction model 153, and the estimation model 155 by the training processing unit 15 of the present modification. In FIG. 5, the acquisition unit 11 and the training processing unit 15 are omitted.

In the present modification, the feature amount calculated by the feature amount calculation unit 12 is input to the estimation unit 135. The estimation unit 135 constructs the estimation model 155 using a data set with a code calculated from raw data and a feature amount calculated from the raw data as explanatory variables and an estimation result associated with the raw data as an objective variable. The estimation unit 135 may construct the estimation model 155 using a data set with a code calculated from raw data and a feature amount reconstructed by inputting the code to the reconstruction model 153 as explanatory variables and an estimation result associated with the raw data as an objective variable.

The training processing unit 15 of the present modification trains the encoding model 151 of the encoding unit 131 and the estimation model 155 of the estimation unit 135 in such a way that the estimation result of the estimation model 155 matches the correct answer data. That is, the training processing unit 15 of the present modification optimizes the model parameters of the encoding model 151 and the estimation model 155 in such a way that the error between the estimation result of the estimation model 155 and the correct answer data is minimized.

The training processing unit 15 of the present modification trains the encoding model 151 of the encoding unit 131 and the reconstruction model 153 of the reconstruction unit 133 in such a way that the reconstruction result (reconstructed feature amount) of the reconstruction model 153 matches the feature amount. That is, the training processing unit 15 optimizes the model parameters of the encoding model 151 and the reconstruction model 153 in such a way that the error between the reconstruction result (reconstructed feature amount) of the reconstruction model 153 and the feature amount is minimized.

In the present modification, estimation is performed using, in addition to a code, a feature amount of original raw data of the code. Therefore, according to the present modification, since information used for estimation increases, accuracy in estimation is improved. The present modification may be further modified, and estimation may be performed using the reconstructed feature amount reconstructed by the reconstruction model 153 using the code in addition to the code. When the method of the present modification is applied to an estimation system (not illustrated), a communication load for transmitting a feature amount occurs, but the estimation accuracy is improved as compared with the method of FIG. 2. In the present modification, an example in which estimation is performed using the feature amount calculated by the feature amount calculation unit 12 and the code calculated using the encoding model 151 is described. The present modification may be configured to perform estimation using a reconstructed feature amount reconstructed using the reconstruction model 153 and a code calculated using the encoding model 151.

As described above, the training device according to the present embodiment includes the acquisition unit, the feature amount calculation unit, the model construction unit, and the training processing unit. The acquisition unit acquires a data set of raw data and correct answer data. The feature amount calculation unit calculates a feature amount using the raw data. The model construction unit constructs the encoding model that outputs a code related to a feature amount in response to an input of the raw data, and the estimation model that outputs an estimation result related to the raw data in response to an input of the code. The model construction unit constructs a reconstruction model that outputs a reconstructed feature amount related to the original feature amount of the code in response to an input of the code. The training processing unit trains the encoding model and the reconstruction model in such a way that the reconstructed feature amount matches the feature amount. The training processing unit trains the encoding model and the estimation model in such a way that the estimation result matches the correct answer data based on the relationship between the code and the feature amount.

The training device of the present embodiment trains the encoding model and the estimation model in such a way that the estimation result matches the correct answer data based on the relationship between the code and the feature amount. Therefore, the training device of the present embodiment can construct an encoding model that outputs a code that maximizes the training effect of the estimation model. The training device of the present embodiment trains the encoding model and the reconstruction model in such a way that a reconstruction result (reconstructed feature amount) by the reconstruction model matches the feature amount. Therefore, the training device of the present embodiment can construct an encoding model that outputs a code that correctly grasps the causal relationship between the raw data and the correct answer data. That is, according to the present embodiment, it is possible to construct a model that maximizes the training effect while correctly grasping the causal relationship.

In an aspect of the present embodiment, the model construction unit constructs the estimation model using the code output from the encoding model in response to an input of the raw data and the feature amount calculated using the raw data. According to the present aspect, more accurate estimation can be performed by using the feature amount in addition to the code.

In an aspect of the present embodiment, the model construction unit constructs the estimation model using the reconstructed feature amount and the code output from the reconstruction model in response to an input of the code. According to the present aspect, more accurate estimation can be performed by using the reconstructed feature amount in addition to the code.

In general, the calculation of the feature amount is a complex algorithm and is described in a high level language. Therefore, every time a new algorithm is developed, it takes time and effort to port the program to the IoT device. As the encoding model according to the present embodiment, a machine training model such as a DNN, a CNN, or an RNN can be used. Therefore, in the method of the present embodiment, when the IoT device includes an environment for executing the machine training model, it is only required to transfer the model. Specifically, in the method of the present embodiment, it is only required to transfer to, the estimation system, model parameters indicating the functional configuration of the model, such as the number of layers of the NN, the number of units of each layer, an activation function, and a combination weight. Therefore, according to the present embodiment, it is possible to save the trouble of porting the program to the IoT device one by one each time a new algorithm is developed.

A training model trained by general machine training can grasp a correlation between the raw data and the correct answer data, but cannot grasp a cause and effect between the raw data and the correct answer data. For example, it is assumed that a training model that makes determination of hallux valgus is trained by machine training using sensor data (gait data) related to the motion of the foot. Hallux valgus tends to be common in women. Therefore, the training model trained by machine training may extract features of the female gait from the gait data. In other words, the training model trained on hallux valgus may be trained to make determination of a female or not based on gait data. That is, when the relationship between the feature amount and the code is not based, the code output from the encoding model includes information for making determination of a female or not. However, there is no causal relationship between being hallux valgus and being female. Therefore, when such a model is applied to a male, the estimation accuracy in the determination of hallux valgus may decrease.

In a general method, since the encoding model and the estimation model are separately designed, it is not possible to evaluate whether the estimation result matches the correct answer data at the design stage of the feature amount. Therefore, it is not always possible to maximize the training effect only by using the feature amount as the code.

In the present embodiment, a feature amount based on knowledge that correctly grasps a causal relationship is introduced into a method utilizing machine training. The training device of the present embodiment trains the encoding model and the estimation model in such a way that the estimation result matches the correct answer data based on the relationship between the code and the feature amount. As a result, the feature amount is reflected in the code input to the estimation model, and the feature based on the causal relationship between the raw data and the estimation result is included in the code. That is, the code output from the encoding model constructed by the training device of the present embodiment includes a feature based on knowledge. According to the present embodiment, it is possible to achieve both the data force and the knowledge force by using the knowledge for the constraint condition of code generation.

For example, based on medical knowledge, pronation of the articulatio subtalaris during walking easily induces hallux valgus. That is, there is a causal relationship between pronation of the ankle and hallux valgus. Therefore, when with the gait feature amount of pronation/supination as a code, an estimation model that estimates the hallux valgus is constructed using the code, the hallux valgus can be estimated regardless of the gender.

### Second Example Embodiment

Next, a training device according to a second example embodiment will be described with reference to the drawings. the training device of the present embodiment is different from that of the first example embodiment in that the encoding model and the estimation model are trained based on a mutual information amount of a code calculated from raw data and a feature amount extracted from the raw data without using a reconstruction model.

### (Configuration)

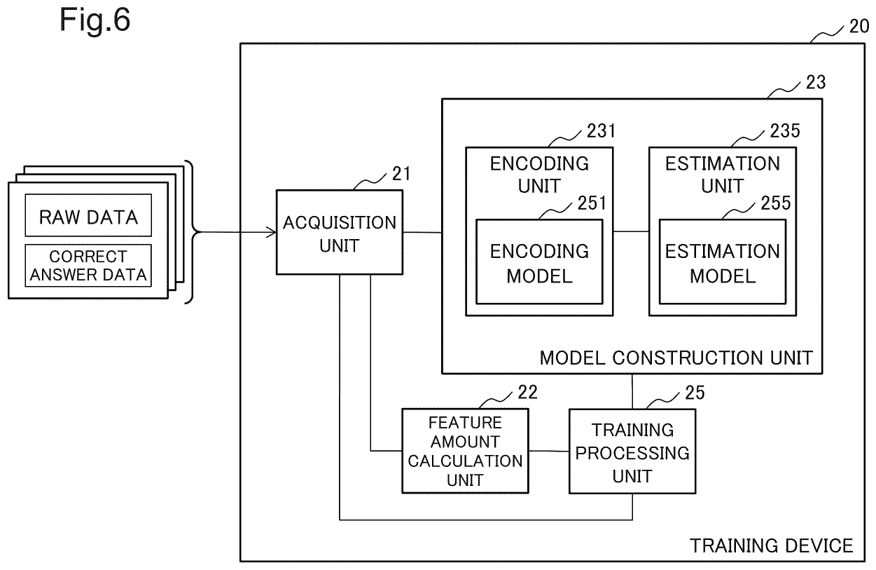

FIG. 6 is a block diagram illustrating an example of a configuration of a training device 20 of the present embodiment. The training device 20 includes an acquisition unit 21, a feature amount calculation unit 22, a model construction unit 23, and a training processing unit 25.

The acquisition unit 21 acquires a plurality of data sets (also referred to as training data sets) used for model construction by the model construction unit 23. The acquisition unit 21 has a configuration similar to that of the acquisition unit 11 of the first example embodiment. The acquisition unit 21 acquires raw data and correct answer data in association with each other from a plurality of data sets included in the training data set.

The feature amount calculation unit 22 acquires raw data from the acquisition unit 21. The feature amount calculation unit 22 has a configuration similar to that of the feature amount calculation unit 12 of the first example embodiment. The feature amount calculation unit 22 calculates a feature amount using the acquired raw data.

The model construction unit 23 acquires raw data from the acquisition unit 21. The model construction unit 23 includes an encoding unit 231 and an estimation unit 235. The model construction unit 23 constructs a model group that outputs an estimation result using the raw data. For example, the model construction unit 23 constructs a machine training model such as a DNN, a CNN, or an RNN. The model constructed by the model construction unit 23 is not limited to a DNN, a CNN, or an RNN. The model group constructed by the model construction unit 23 is trained by machine training by the training processing unit 25.

The encoding unit 231 includes an encoding model 251. The encoding unit 231 has a configuration similar to that of the encoding unit 131 of the first example embodiment. The encoding model 251 has a configuration similar to that of the encoding model 151 of the first example embodiment. The encoding unit 231 constructs the encoding model 251 that outputs a code in response to an input of raw data.

The estimation unit 235 includes an estimation model 255. The estimation unit 235 constructs the estimation model 255 that outputs the estimation result related to the raw data in response to inputs of the code calculated by the encoding unit 231 and the feature amount of the raw data that is the original of the code. For example, the estimation unit 235 constructs the estimation model 255 that outputs the estimation result in response to inputs of the code and the feature amount by supervised training using a data set of the code, the feature amount of the original raw data of the code, and the correct answer data related to the raw data.

The training processing unit 25 trains the model group constructed in the model construction unit 23 by machine training. That is, the training processing unit 25 trains the encoding model 251 and the estimation model 255 constructed in the model construction unit 23 by machine training.

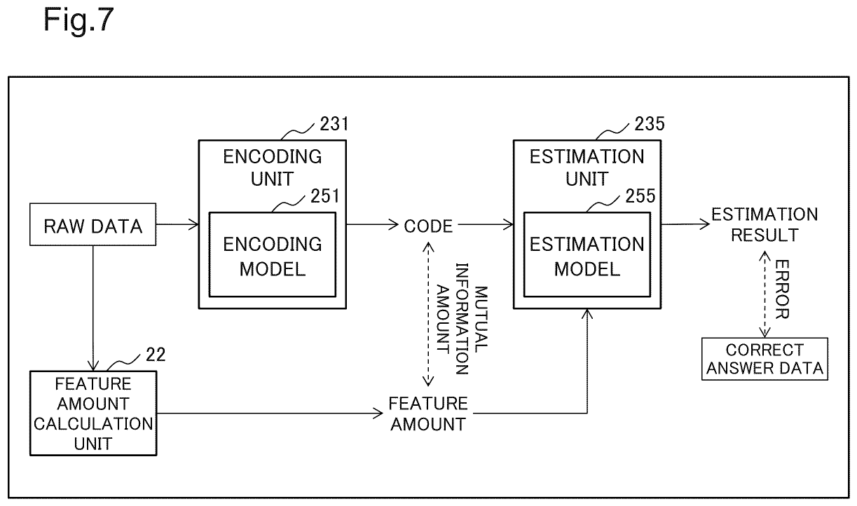

FIG. 7 is a conceptual diagram for explaining training of the encoding model 251 and the estimation model 255 by the training processing unit 25. In FIG. 7, the acquisition unit 21 and the training processing unit 25 are omitted.

The training processing unit 25 trains the encoding model 251 of the encoding unit 231 and the estimation model 255 of the estimation unit 235 in such a way that the estimation result of the estimation model 255 matches the correct answer data. That is, the training processing unit 25 optimizes the model parameters of the encoding model 251 and the estimation model 255 in such a way that the error between the estimation result of the estimation model 255 and the correct answer data is minimized.

The training processing unit 25 calculates a mutual information amount of the code output from the encoding model 251 and the feature amount calculated from the original raw data of the code. The training processing unit 25 trains the encoding model 251 of the encoding unit 231 and the estimation model 255 of the estimation unit 235 in such a way that the mutual information amount of the code and the feature amount calculated from the original raw data of the code is reduced. That is, the training processing unit 25 optimizes the model parameters of the encoding model 251 and the estimation model 255 in such a way that the mutual information amount of the code and the feature amount calculated from the original raw data of the code is reduced. For example, assuming that the random variable of the code is X and the random variable of the feature amount is Y, the training processing unit 25 calculates a mutual information amount I using the following mathematical Formula.

$$I ( X ; Y ) = \int \int p ( x , y ) log \frac{p ( x , y )}{p ( x ) p ( y )} d xdy \qquad ( 1 )$$

Where, in the above Formula 1, p(x, y) represents the simultaneous distribution of the random variable X and the random variable Y. p(x) is a probability density function representing the peripheral distribution of the random variable X, and p(y) is a probability density function representing the peripheral distribution of the random variable Y.

In the present embodiment, the encoding model 251 and the estimation model 255 are trained in such a way that the mutual information amount of the code and the feature amount calculated from the original raw data of the code is reduced. As a result, the encoding model 251 encodes information that complements the feature amount. As a result, according to the present embodiment, the load on the calculation resources such as the calculation time, the memory, and the power can be reduced as compared with the first example embodiment.

The model trained by the training processing unit 25 is implemented in an estimation system (not illustrated) that performs estimation based on raw data. For example, the estimation system includes a measurement device (not illustrated) that measures measurement data (raw data) and an estimation device (not illustrated) that performs estimation based on the measurement data. For example, the encoding model is implemented in the measurement device, and the estimation model is implemented in the estimation device. The measurement device encodes the measurement data using the encoding model and calculates a feature amount of the measurement data. The measurement device transmits the code and the feature amount of the original raw data of the code to the estimation model. The estimation device inputs the code and the feature amount received from the measurement device to the estimation model to output an estimation result by the estimation model. Details of the estimation system using the model trained by the training processing unit 25 will be described later.

### (Operation)

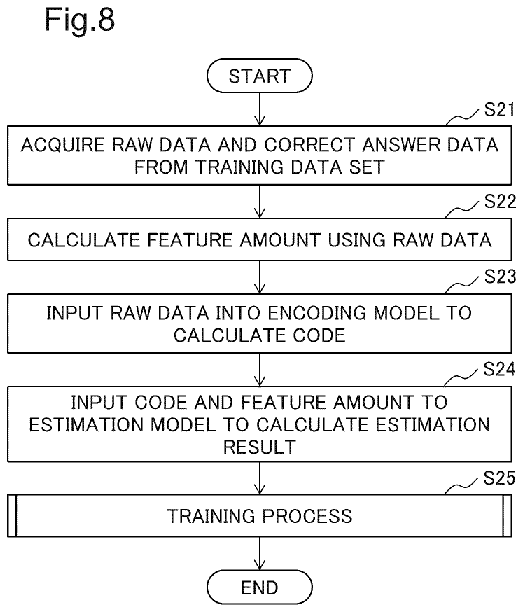

Next, the operation of the training device 20 of the present embodiment will be described with reference to the drawings. FIG. 8 is a flowchart for explaining an example of the operation of the training device 20. In the description along the flowchart of FIG. 8, the components of the training device 20 will be mainly described.

In FIG. 8, first, the acquisition unit 21 acquires raw data and correct answer data from the training data set (step S21).

Next, the feature amount calculation unit 22 calculates a feature amount using the raw data (step S22).

Next, the encoding unit 231 inputs the raw data to the encoding model 251 and calculates a code (step S23).

Next, the estimation unit 235 inputs the code and the feature amount of the original raw data of the code to the estimation model 255 and calculates an estimation result (step S24).

Next, the training processing unit 25 executes a training process (step S25). Details of the training process will be described later. The model parameters of the model trained by the training processing unit 25 are set in an encoding model and an estimation model implemented in an estimation system (not illustrated).

### [Training Process]

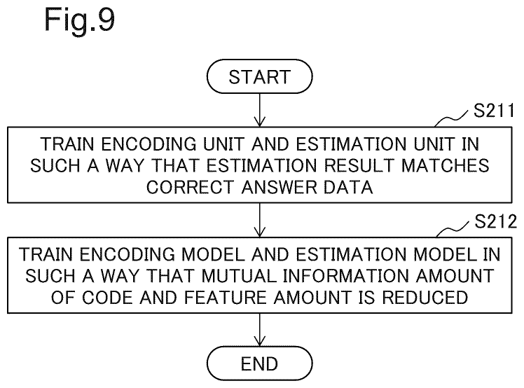

Next, the training process (step S25 in FIG. 8) by the training processing unit 25 will be described with reference to the drawings. FIG. 9 is a flowchart for explaining the training process by the training processing unit 25. In the processing along the flowchart of FIG. 9, the training processing unit 25 will be described as an operation subject.

In FIG. 9, first, the training processing unit 25 trains the encoding model 251 of the encoding unit 231 and the estimation model 255 of the estimation unit 235 in such a way that the estimation result using the estimation model 255 matches the correct answer data (step S211).

Next, the training processing unit 25 trains the encoding model 251 of the encoding unit 231 and the estimation model 255 of the estimation unit 235 in such a way that the mutual information amount of the code and the feature amount is reduced (step S212). The model parameters of the model trained by the training processing unit 25 are set in an encoding model and an estimation model implemented in an estimation system (not illustrated).

### Second Modification

Next, the second modification of the present embodiment will be described with reference to the drawings. In the present modification, the training processing unit 25 does not calculate the mutual information amount of the code and the feature amount.

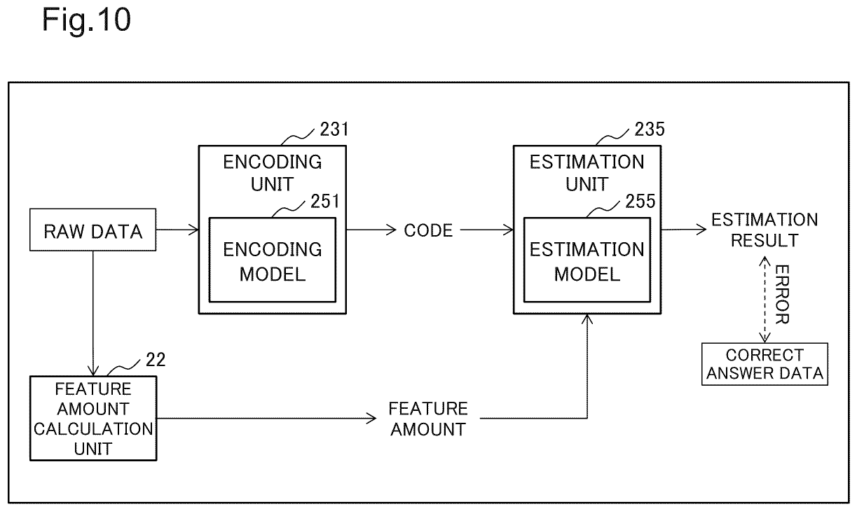

FIG. 10 is a conceptual diagram for explaining training of the encoding model 251 and the estimation model 255 by the training processing unit 25 of the present modification. In FIG. 10, the acquisition unit 21 and the training processing unit 25 are omitted.

In the present modification, the feature amount calculated by the feature amount calculation unit 22 is input to the estimation unit 235. The estimation unit 235 constructs the estimation model 255 using a data set with a code calculated from raw data and a feature amount calculated from the raw data as explanatory variables and an estimation result associated with the raw data as an objective variable.

The training processing unit 25 of the present modification trains the encoding model 251 of the encoding unit 231 and the estimation model 255 of the estimation unit 235 in such a way that the estimation result of the estimation model 255 matches the correct answer data. That is, the training processing unit 25 of the present modification optimizes the model parameters of the encoding model 251 and the estimation model 255 in such a way that the error between the estimation result of the estimation model 255 and the correct answer data is minimized.

In the present modification, there is a possibility that the overlap of the information of the code and the information of the feature amount increases, but since the mutual information amount of the code and the feature amount is not calculated, the calculation resource can be simplified as compared with the method of FIG. 7.

As described above, the training device according to the present embodiment includes the acquisition unit, the feature amount calculation unit, the model construction unit, and the training processing unit. The acquisition unit acquires a data set of raw data and correct answer data. The feature amount calculation unit calculates a feature amount using the raw data. The model construction unit constructs the encoding model that outputs a code related to a feature amount in response to an input of the raw data, and the estimation model that outputs an estimation result related to the raw data in response to an input of the code. The training processing unit trains the encoding model and the estimation model in such a way that the estimation result matches the correct answer data based on the relationship between the code and the feature amount.

The training device of the present embodiment trains the encoding model and the estimation model in such a way that the estimation result of the estimation model matches the correct answer data. Therefore, according to the present embodiment, the encoding unit can generate a code that maximizes the training effect.

In an aspect of the present embodiment, the training processing unit trains the estimation model in such a way that a mutual information amount of a code output from the encoding model in response to an input of the raw data and a feature amount calculated using the raw data is reduced. According to the present aspect, since the encoding model is trained in such a way that the mutual information amount of the code and the feature amount is reduced, the code generated by the encoding unit does not overlap the information included in the feature amount. That is, according to the method of the present embodiment, the training effect can be maximized while correctly grasping the causal relationship by combining the code and the feature amount in the complementary relationship. As a result, according to the present embodiment, as in the first example embodiment, it is possible to construct a model that maximizes the training effect while correctly grasping the causal relationship.

In an aspect of the present embodiment, the model construction unit constructs the estimation model using the code output from the encoding model in response to an input of the raw data and the feature amount calculated using the raw data. According to the present aspect, more accurate estimation can be performed by using the feature amount in addition to the code at the time of estimation using the estimation model.

In the method of the first example embodiment, it is necessary to increase or complicate the scale of the machine training model according to the complexity of the algorithm for calculating the feature amount. This is because when the degree of freedom of the machine training model is not sufficiently high so as to be able to cope with the complexity of the algorithm for calculating the feature amount, the feature amount cannot be reconstructed and the performance is deteriorated. As the machine training model is larger/more complicated, loads on calculation resources such as time, memory, and power may increase. On the other hand, in the method of the present embodiment, since the encoding model encodes only the information that complements the feature amount, a small-scale and simple model is sufficient as compared with the first example embodiment. Therefore, according to the present embodiment, the load on the calculation resources can be reduced as compared with the first example embodiment.

### Third Example Embodiment

Next, a training device according to a third example embodiment will be described with reference to the drawings. The training device of the present embodiment is different from the first and second example embodiments in that an individually pre-trained encoding model and an individually pre-trained estimation model are combined and fine-tuned.

### (Configuration)

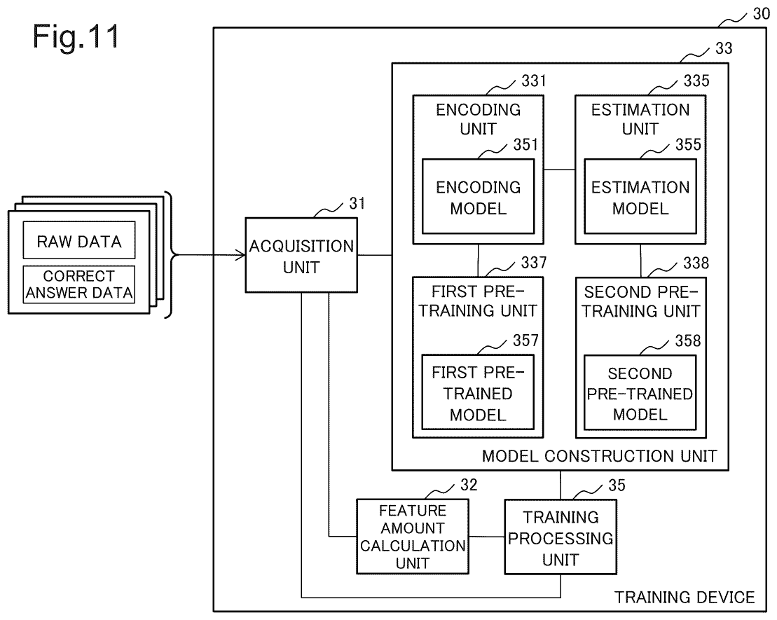

FIG. 11 is a block diagram illustrating an example of a configuration of a training device 30 of the present embodiment. The training device 30 includes an acquisition unit 31, a feature amount calculation unit 32, a model construction unit 33, and a training processing unit 35.

The acquisition unit 31 acquires a plurality of data sets (also referred to as training data sets) used for model construction by the model construction unit 33. The acquisition unit 31 has a configuration similar to that of the acquisition unit 11 of the first example embodiment. The acquisition unit 31 acquires raw data and correct answer data in association with each other from a plurality of data sets included in the training data set.

The feature amount calculation unit 32 acquires raw data from the acquisition unit 31. The feature amount calculation unit 32 has a configuration similar to that of the feature amount calculation unit 12 of the first example embodiment. The feature amount calculation unit 32 calculates a feature amount using the acquired raw data.

The model construction unit 33 acquires raw data from the acquisition unit 31. The model construction unit 33 includes an encoding unit 331, an estimation unit 335, a first pre-training unit 337, and a second pre-training unit 338. The model construction unit 33 constructs a model group that outputs an estimation result using the raw data. For example, the model construction unit 33 constructs a machine training model such as a DNN, a CNN, or an RNN. The model constructed by the model construction unit 33 is not limited to a DNN, a CNN, or an RNN. The model group constructed by the model construction unit 33 is trained by machine training by the training processing unit 35.

The encoding unit 331 includes an encoding model 351. The encoding unit 331 has a configuration similar to that of the encoding unit 131 of the first example embodiment. The encoding model 351 has a configuration similar to that of the encoding model 151 of the first example embodiment. It is difference from the encoding unit 131 of the first example embodiment in that model parameter of a first pre-trained model 357 constructed in the first pre-training unit 337 is set in the encoding model 351. The encoding unit 331 constructs an encoding model 351 that outputs a code in response to an input of raw data.

The estimation unit 335 includes an estimation model 355. The estimation unit 335 has a configuration similar to that of the estimation unit 135 of the first example embodiment. It is difference from the encoding unit 131 of the first example embodiment in that model parameter of a second pre-trained model 358 constructed in the second pre-training unit 338 is set in the estimation model 355. The estimation unit 335 constructs the estimation model 355 that outputs the estimation result related to the original raw data of the code in response to an input of the code calculated by the encoding unit 331.

The first pre-training unit 337 includes the first pre-trained model 357. The first pre-training unit 337 constructs the first pre-trained model 357 that outputs the first conversion value in response to an input of the raw data. The first conversion value is an estimation value related to the feature amount calculated from the raw data. For example, the first pre-training unit 337 constructs the first pre-trained model 357 that outputs the first conversion value in response to an input of the raw data by the supervised training using the data set of the raw data and the feature amount related to the raw data. The first conversion value includes a feature similar to that of the feature amount related to the first conversion value.

The second pre-training unit 338 includes the second pre-trained model 358. The second pre-training unit 338 constructs the second pre-trained model 358 that outputs the second conversion value in response to an input of the feature amount. The second conversion value is an estimation value related to the correct answer data paired with the original raw data of the feature amount. For example, the second pre-training unit 338 constructs the second pre-trained model 358 that outputs the second conversion value in response to an input of the feature amount by the supervised training using the data set of the feature amount and the correct answer data paired with the original raw data of the feature amount. For example, the second pre-training unit 338 may construct the second pre-trained model 358 that outputs the second conversion value in response to an input of the reconstructed feature amount by the supervised training using the data set of the reconstructed feature amount and the correct answer data paired with the original raw data of the reconstructed feature amount. The second conversion value includes a feature similar to that of the correct answer data related to the second conversion value.

The training processing unit 35 trains the model group constructed in the model construction unit 33 by machine training. That is, the training processing unit 35 trains the encoding model 351, the estimation model 355, the first pre-trained model 357, and the second pre-trained model 358 constructed in the model construction unit 33 by machine training.

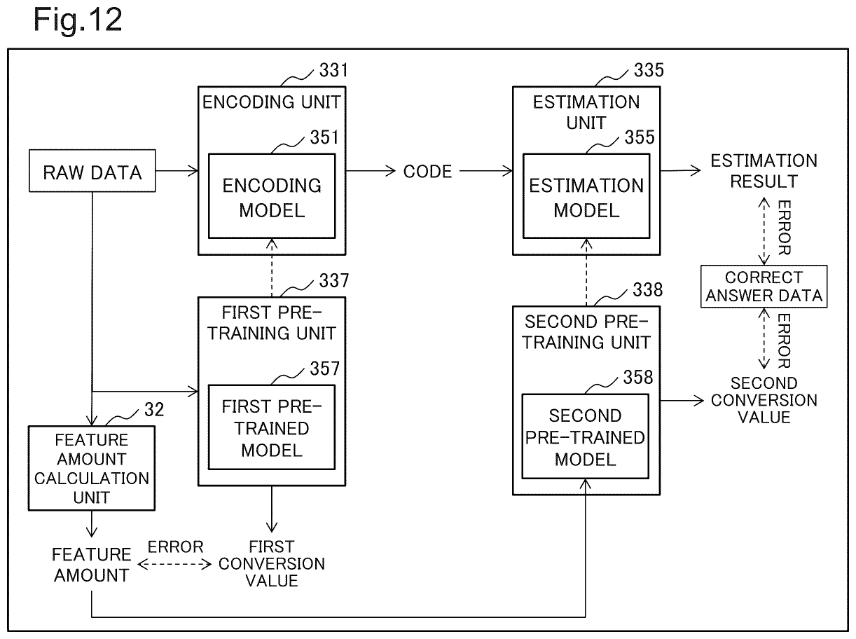

FIG. 12 is a conceptual diagram for explaining training of the encoding model 351, the estimation model 355, the first pre-trained model 357, and the second pre-trained model 358 by the training processing unit 35. In FIG. 12, the acquisition unit 31 and the training processing unit 35 are omitted.

The training processing unit 35 trains the first pre-trained model 357 of the first pre-training unit 337 in such a way that a first conversion value that is an output of the first pre-trained model 357 matches a feature amount calculated from original raw data of the first conversion value. That is, the training processing unit 35 optimizes the model parameter of the first pre-trained model 357 in such a way that the error between the first conversion value and the feature amount calculated from the original raw data of the first conversion value is minimized.

The training processing unit 35 trains the second pre-trained model 358 of the second pre-training unit 338 in such a way that the second conversion value that is an output of the second pre-trained model 358, matches a correct answer data related to the original raw data of the second conversion value. That is, the training processing unit 35 optimizes the model parameter of the second pre-trained model 358 in such a way that the error between the second conversion value and the correct answer data related to the original raw data of the second conversion value is minimized.

The training processing unit 35 sets the model parameter of the first pre-trained model 357 optimized by training in the encoding model 351. The training processing unit 35 sets the model parameter of the second pre-trained model 358 optimized by training in the estimation model 355.

The training processing unit 35 trains the encoding model 351 of the encoding unit 331 and the estimation model 355 of the estimation unit 335 in such a way that the estimation result of the estimation model 355 matches the correct answer data. That is, the training processing unit 35 optimizes the model parameters of the encoding model 351 and the estimation model 355 in such a way that the error between the estimation result of the estimation model 355 and the correct answer data is minimized.

In the present embodiment, the model parameter of the first pre-training model trained in such a way that the first conversion value calculated using the raw data matches the feature amount is set as the initial value of the encoding model 351. Therefore, the characteristic of the feature amount remains in the encoding model 351, and it is possible to generate a code that correctly grasps the causal relationship between the raw data and the correct answer data. The encoding model 351 and the estimation model 355 are trained in such a way that the estimation result matches the correct answer data. Therefore, the encoding model 351 can output the code in which the training effect is maximized.

The model trained by the training processing unit 35 is implemented in an estimation system (not illustrated) that performs estimation based on raw data. For example, the estimation system includes a measurement device (not illustrated) that measures measurement data (raw data) and an estimation device (not illustrated) that performs estimation based on the measurement data. For example, the encoding model is implemented in the measurement device, and the estimation model is implemented in the estimation device. The measurement device encodes the measurement data using the encoding model and calculates a feature amount of the measurement data. The measurement device transmits the code and the feature amount of the original raw data of the code to the estimation model. The estimation device inputs the code and the feature amount received from the measurement device to the estimation model to output an estimation result by the estimation model. Details of the estimation system using the model trained by the training processing unit 35 will be described later.

### (Operation)

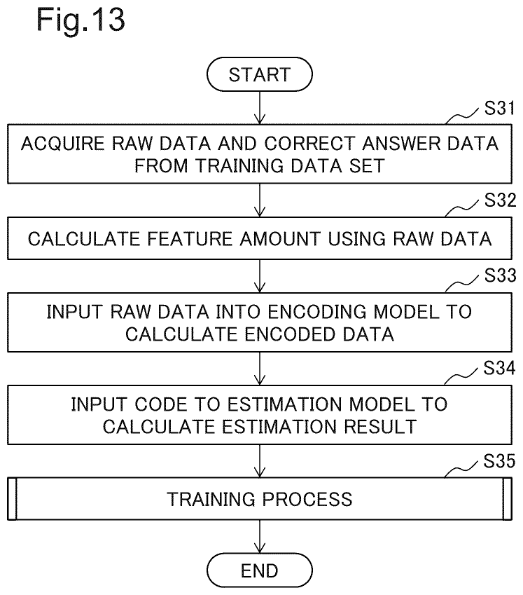

Next, the operation of the training device 30 of the present embodiment will be described with reference to the drawings. FIG. 13 is a flowchart for explaining an example of the operation of the training device 30. In the description along the flowchart of FIG. 13, the components of the training device 30 will be mainly described.

In FIG. 13, first, the acquisition unit 31 acquires raw data and correct answer data from the training data set (step S31).

Next, the feature amount calculation unit 32 calculates a feature amount using the raw data (step S32).

Next, the encoding unit 331 inputs the raw data to the encoding model 351 and calculates a code (step S33).

Next, the estimation unit 335 inputs the code to the estimation model 355 and calculates an estimation result (step S34).

Next, the training processing unit 35 executes a training process (step S35). Details of the training process will be described later. The model parameter of the model trained by the training processing unit 35 are set in an encoding model and an estimation model implemented in the estimation system (not illustrated).

### [Training Process]

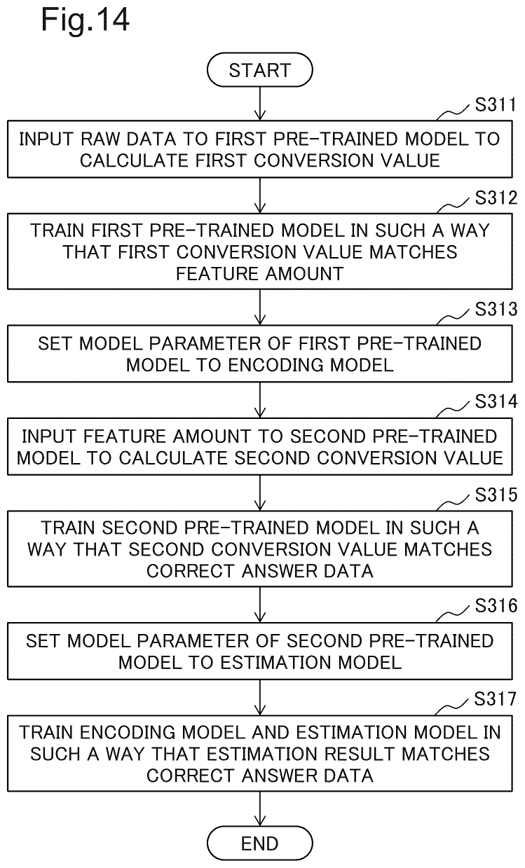

Next, the training process (step S35 in FIG. 13) by the training processing unit 35 will be described with reference to the drawings. FIG. 14 is a flowchart for explaining a training process by the training processing unit 35. In the processing along the flowchart of FIG. 14, the training processing unit 35 will be described as an operation subject.

In FIG. 14, first, the training processing unit 35 inputs raw data to the first pre-trained model 357 and calculates a first conversion value (step S311).

Next, the training processing unit 35 trains the first pre-trained model 357 in such a way that the first transformation amount matches the feature amount (step S312).

Next, the training processing unit 35 sets the model parameter of the first pre-trained model 357 in the encoding model 351 (step S313).

Next, the training processing unit 35 inputs the feature amount to the second pre-trained model 358 to calculate a second conversion value (step S314).

Next, the training processing unit 35 trains the second pre-trained model 358 in such a way that the second conversion amount matches the correct answer data (step S315).

Next, the training processing unit 35 sets the model parameter of the second pre-trained model 358 in the estimation model 355 (step S316). Steps S314 to S316 may be performed before steps S311 to S313, or may be performed in parallel with steps S311 to S313.

Next, the training processing unit 35 trains the encoding model 351 of the encoding unit 331 and the estimation model 355 of the estimation unit 335 in such a way that the estimation result of the estimation model 355 matches the correct answer data (step S317).

As described above, the training device according to the present embodiment includes the acquisition unit, the feature amount calculation unit, the model construction unit, and the training processing unit. The acquisition unit acquires a data set of raw data and correct answer data. The feature amount calculation unit calculates a feature amount using the raw data. The model construction unit constructs the encoding model that outputs a code related to a feature amount in response to an input of the raw data, and the estimation model that outputs an estimation result related to the raw data in response to an input of the code. The model construction unit constructs a first pre-training model that outputs a first conversion value related to the feature amount in response to an input of the raw data. The training processing unit trains the first pre-training model in such a way that the first conversion value matches the feature amount. The training processing unit sets a model parameter of the first pre-training model after training as an initial value of the encoding model. The training processing unit trains the encoding model and the estimation model in such a way that the estimation result matches the correct answer data.

In the present embodiment, the model parameter of the first pre-training model trained in such a way that the first conversion value calculated using the raw data matches the feature amount is used as the initial value of the model parameter of the encoding model. Therefore, according to the present embodiment, it is possible to construct an encoding model that outputs a code that correctly grasps a causal relationship while including the characteristic of the feature amount. That is, according to the present aspect, as in the first and second example embodiments, it is possible to construct a model that performs estimation with high accuracy while correctly grasping a causal relationship using a code obtained by reducing the dimension of raw data.

In the present embodiment, the model parameter of the second pre-training model trained in such a way that the second conversion value calculated using the feature amount matches the correct answer data is used as the initial value of the model parameter of the estimation model. Therefore, according to the present embodiment, by training the association between the feature amount and the correct answer data in advance, fine tuning of the encoding model and the estimation model can be converged early.

### Fourth Example Embodiment

Next, a training device according to a fourth example embodiment will be described with reference to the drawings. The training device of the present embodiment has a configuration in which the training device of each of the first and third example embodiments is simplified.

### (Configuration)

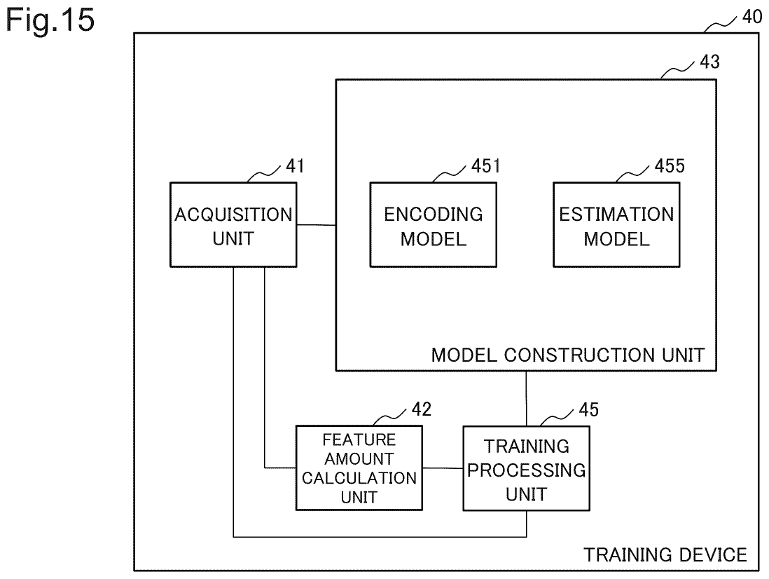

FIG. 15 is a block diagram illustrating an example of a configuration of a training device 40 of the present embodiment. The training device 40 includes an acquisition unit 41, a feature amount calculation unit 42, a model construction unit 43, and a training processing unit 45. The model construction unit 43 includes an encoding model 451 and an estimation model 455.

The acquisition unit 41 acquires a data set of raw data and correct answer data. The feature amount calculation unit 42 calculates a feature amount using the raw data. The model construction unit 43 constructs an encoding model that outputs a code related to the feature amount in response to an input of the raw data. The model construction unit 43 constructs an estimation model that outputs an estimation result related to the raw data in response to an input of the code. The training processing unit 45 trains the encoding model 451 and the estimation model 455 in such a way that the estimation result matches the correct answer data based on the relationship between the code and the feature amount.

According to the training device of the present embodiment, by training the encoding model and the estimation model based on the relationship between the code and the feature amount, it is possible to construct a model that performs highly accurate estimation while correctly grasping the causal relationship using the code obtained by reducing the dimension of the raw data.

### Fifth Example Embodiment

Next, an estimation system according to a fifth example embodiment will be described with reference to the drawings. The estimation system of the present embodiment includes the encoding model and the estimation model constructed by the training device of the first or third example embodiment. The estimation system according to the present embodiment measures a physical quantity (sensor data) related to the motion of a foot by a measurement device installed on footwear worn by a user. For example, the physical quantity related to the motion of the foot includes accelerations in the three axis directions (also referred to as spatial accelerations) measured by the acceleration sensor, angular velocities around the three axes (also referred to as spatial angular velocities) measured by the angular velocity sensor, and the like. The estimation system of the present embodiment estimates the gait and physical condition of the user based on the measured sensor data.

### (Configuration)

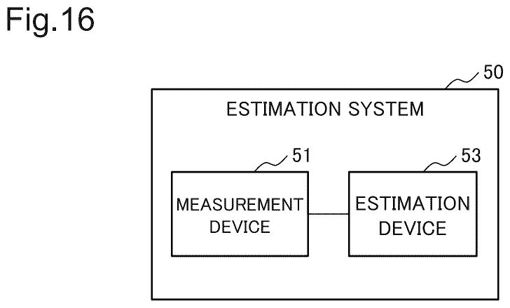

FIG. 16 is a block diagram illustrating an example of a configuration of an estimation system 50 of the present embodiment. The estimation system 50 includes a measurement device 51 and an estimation device 53. The measurement device 51 and the estimation device 53 may be connected by wire or wirelessly. The measurement device 51 and the estimation device 53 may be configured by a single device.

The measurement device 51 is installed at the foot portion. For example, the measurement device 51 is installed at footwear such as a shoe. In the present embodiment, an example in which the measurement device 51 is disposed at a position on the back side of the arch of foot will be described. The measurement device 51 includes, for example, an inertial measurement device including an acceleration sensor and an angular velocity sensor. An example of the inertial measurement device is an inertial measurement unit (IMU). The IMU includes the acceleration sensor that measures acceleration in the three axis directions and the angular velocity sensor that measures angular velocities around the three axes. The measurement device 51 may be achieved by an inertial measurement device such as a vertical gyro (VG) or an attitude heading (AHRS). The measurement device 51 may be achieved by a global positioning system/inertial navigation system (GPS/INS). The measurement device 51 includes a microcomputer and a microcontroller that perform a control process and an arithmetic process of the measurement device 51, and a real-time clock (hereinafter, also referred to as a clock) that clocks time. The microcomputer and the microcontroller are also referred to as a control unit (controller).

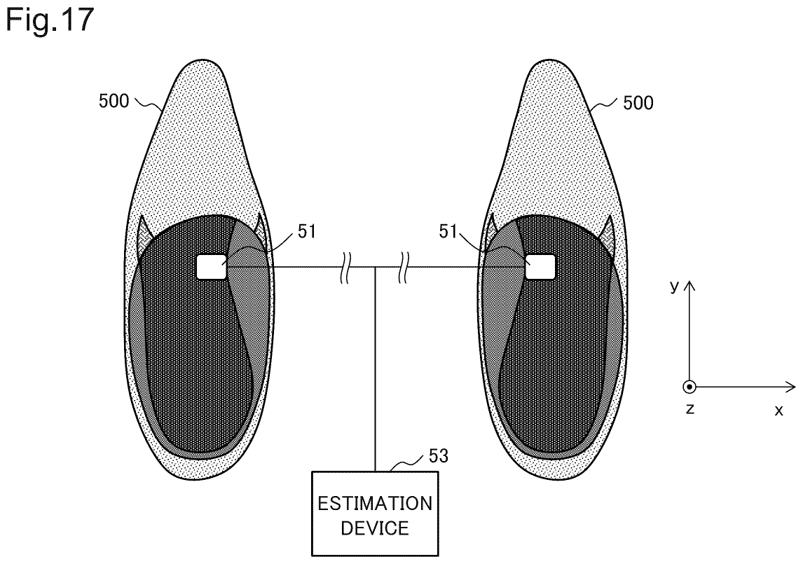

FIG. 17 is a conceptual diagram illustrating an example in which the measurement device 51 is disposed in each of the shoes 500. In the example of FIG. 17, the measurement device 51 is installed at a position corresponding to the back side of the arch of foot. For example, the measurement device 51 is disposed at an insole inserted into the shoe 500. For example, the measurement device 51 is disposed at the bottom face of the shoe 500. For example, the measurement device 51 is embedded in the main body of the shoe 500. The measurement device 51 may be detachable from the shoe 500 or may not be detachable from the shoe 500. The measurement device 51 may be installed at a position other than the back side of the arch of foot as long as the sensor data regarding the motion of the foot can be acquired. The measurement device 51 may be installed at a sock worn by the user or a decorative article such as an anklet worn by the user. The measurement device 51 may be directly attached to the foot or may be embedded in the foot. FIG. 17 illustrates an example in which the measurement device 51 is installed at each of the shoes 500 of both right and left feet, but the measurement device 51 may be installed at the shoe 500 of one foot.

The measurement device 51 includes an acceleration sensor and an angular velocity sensor. The measurement device 51 measures, as a physical quantity related to the motion of the foot of the user wearing the footwear, physical quantities such as accelerations in the three axis directions (also referred to as spatial accelerations) measured by the acceleration sensor and angular velocities around the three axes (also referred to as spatial angular velocities) measured by the angular velocity sensor. The physical quantity related to the motion of the foot measured by the measurement device 51 also includes a speed and a position (trajectory) in each of the three axis directions and an angle around each of the three axes calculated by integrating the acceleration and the angular velocity. The measurement device 51 converts the measured analog data (physical quantity) into digital data (also referred to as sensor data).

An encoding model constructed by the training device of the first or third example embodiment is implemented in the measurement device 51. For example, the model parameter set by the training device according to the first or third example embodiment is set in the encoding model. The measurement device 51 inputs the converted sensor data to the encoding model to encode the sensor data.

The measurement device 51 transmits the encoded sensor data (code) to the estimation device 53. For example, the measurement device 51 is connected to the estimation device 53 via a mobile terminal (not illustrated) carried by the user. In a case where the communication between the measurement device 51 and the mobile terminal is successful and the code is transmitted from the measurement device 51 to the mobile terminal, the measurement in the measurement time zone is ended. For example, when the communication between the measurement device 51 and the mobile terminal is successful, the clock time of the measurement device 51 may be synchronized with the clock time of the mobile terminal. When the communication between the measurement device 51 and the mobile terminal fails and the code is not transmitted from the measurement device 51 to the mobile terminal, the code in the measurement time zone may be retransmitted in the next or subsequent measurement time zone. For example, when the communication between the measurement device 51 and the mobile terminal fails, the transmission of the code in the measurement time zone may be repeated until the communication succeeds. For example, when the communication between the measurement device 51 and the mobile terminal fails, the transmission of the code in the measurement time zone may be repeated within a predetermined time. The code is the measurement time zone in which the transmission has failed may be stored in a storage device (not illustrated) such as an electrically erasable programmable read only memory (EEPROM) until the next transmission timing.

In a case where the measurement devices 51 are mounted on both the right and left feet, the clock times of the measurement devices 51 are synchronized with the time of the mobile terminal, so that the times of the measurement devices 51 mounted on both feet can be synchronized. The measurement devices 51 mounted on both feet may perform measurement at the same timing or may perform measurement at different timings. For example, in a case where the measurement timings by the measurement devices 51 mounted on both feet are greatly deviated based on the measurement times of both feet and the number of measurement failures, correction may be performed to reduce the deviation between the measurement timings. The correction of the measurement timing may be performed by the estimation device 53 that can process the code transmitted from the measurement devices 51 installed at each of both feet or a higher-level system.

A mobile terminal (not illustrated) connected to the measurement device 51 is achieved by a communication device that can be carried by a user. For example, the mobile terminal is a portable communication device having a communication function, such as a smartphone, a smart watch, or a mobile phone. The mobile terminal receives sensor data related to the motion of the user's foot from the measurement device 51. The mobile terminal transmits the received code to a cloud, a server, or the like where the estimation device 53 is mounted. The function of the estimation device 53 may be implemented by application software or the like (also referred to as an application) installed in the mobile terminal. In this case, the mobile terminal processes the received code by an application installed in the mobile terminal.

For example, when the use of the estimation system 50 of the present embodiment is started, an application for executing the function of the estimation system 50 is downloaded to the mobile terminal of the user, and the user information is registered. For example, when the user information is registered in the measurement device 51, by synchronizing the time of the mobile terminal with the clock time of the measurement device 51, the time unique to the measurement device 51 can be set according to the universal time.

The estimation device 53 acquires the code from the measurement device 51. An estimation model constructed by the training device according to the first or third example embodiment is implemented in the estimation device 53. The model parameter set by the training device according to the first or third example embodiment is set in the estimation model. The measurement device 51 inputs the acquired code to the estimation model to output an estimation result using the original sensor data (raw data) of the code. For example, the estimation device 53 estimates a score regarding the gait of the user. For example, the score is a value obtained by indexing the evaluation regarding the gait of the user. For example, the estimation device 53 estimates the physical condition of the user. For example, the physical condition includes the degree of pronation/supination of the foot, the degree of progression of hallux valgus, the degree of progression of gonarthritis, muscle strength, balance ability, flexibility of the body, and the like. The estimation process by the estimation device 53 is not particularly limited as long as it is the estimation process related to the gait.

For example, the estimation device 53 is mounted in a cloud, a server, or the like (not illustrated). For example, the estimation device 53 may be achieved by an application server. For example, the estimation device 53 may be achieved by an application installed in a mobile terminal (not illustrated). For example, a result of the estimation process by the estimation device 53 is displayed on a screen (not illustrated) of a mobile terminal or a terminal device (not illustrated) carried by the user. For example, the result of the estimation process by the estimation device 53 is output to a system that uses the result. The use of the result of the estimation process by the estimation device 53 is not particularly limited.

### [Measurement Device]

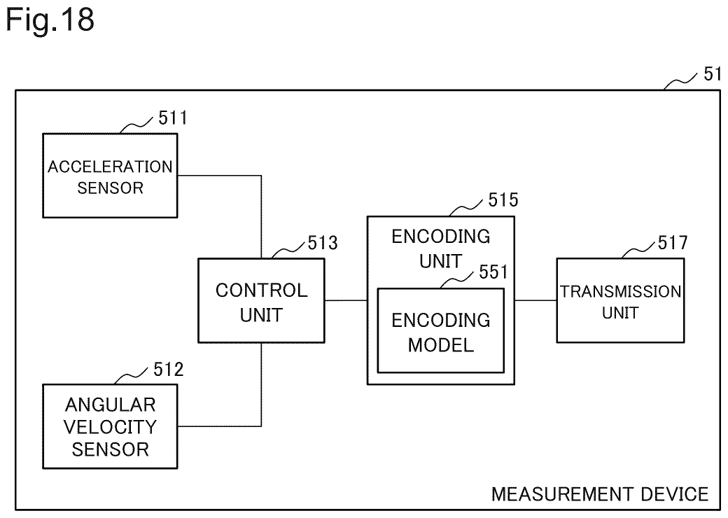

Next, a detailed configuration of the measurement device 51 will be described with reference to the drawings. FIG. 18 is a block diagram illustrating an example of a detailed configuration of the measurement device 51. The measurement device 51 includes an acceleration sensor 511, an angular velocity sensor 512, a control unit 513, an encoding unit 515, and a transmission unit 517. The measurement device 51 includes a real-time clock and a power supply (not illustrated).

The acceleration sensor 511 is a sensor that measures accelerations (also referred to as spatial accelerations) in the three axis directions. The acceleration sensor 511 outputs the measured acceleration to the control unit 513. For example, a sensor of a piezoelectric type, a piezoresistive type, a capacitance type, or the like can be used as the acceleration sensor 511. As long as the sensor used for the acceleration sensor 511 can measure an acceleration, the measurement method is not limited.

The angular velocity sensor 512 is a sensor that measures angular velocities in the three axis directions (also referred to as spatial angular velocities). The angular velocity sensor 512 outputs the measured angular velocity to the control unit 513. For example, a sensor of a vibration type, a capacitance type, or the like can be used as the angular velocity sensor 512. As long as the sensor used for the angular velocity sensor 512 can measure an angular velocity, the measurement method is not limited.

The control unit 513 acquires the acceleration in each of the three axis directions and the angular velocity around each of the three axes from each of the acceleration sensor 511 and the angular velocity sensor 512. The control unit 513 converts the acquired acceleration and angular velocity into digital data to output the converted digital data (also referred to as sensor data) to the encoding unit 515. The sensor data includes at least acceleration data converted into digital data and angular velocity data converted into digital data. The acceleration data includes acceleration vectors in the three axis directions. The angular velocity data includes angular velocity vectors around the three axes. The acquisition times of the acceleration data and the angular velocity data are associated with the acceleration data and the angular velocity data. The control unit 513 may be configured to output sensor data obtained by adding correction such as a mounting error, temperature correction, and linearity correction to the acquired acceleration data and angular velocity data. The control unit 513 may generate angle data around the three axes using the acquired acceleration data and angular velocity data.

For example, the control unit 513 is a microcomputer or a microcontroller that performs overall control and data processing of the measurement device 51. For example, the control unit 513 includes a central processing unit (CPU), a random access memory (RAM), a read only memory (ROM), a flash memory, and the like. The control unit 513 controls the acceleration sensor 511 and the angular velocity sensor 512 to measure the angular velocity and the acceleration. For example, the control unit 513 performs analog-to-digital conversion (AD conversion) on physical quantities (analog data) such as the measured angular velocity and acceleration, and stores the converted digital data in the flash memory. The physical quantity (analog data) measured by each of the acceleration sensor 511 and the angular velocity sensor 512 may be converted into digital data in each of the acceleration sensor 511 and the angular velocity sensor 512. The digital data stored in the flash memory is output to the encoding unit 515 at a predetermined timing.

The encoding unit 515 acquires sensor data from the control unit 513. The encoding unit 515 includes an encoding model 551. The encoding model 551 is an encoding model constructed by the training device of the first or third example embodiment. For example, the model parameter set by the training device according to the first or third example embodiment is set in the encoding model 551. The encoding unit 515 inputs the acquired sensor data to the encoding model 551 and encodes the sensor data. The encoding unit 515 outputs a code obtained by encoding the sensor data to the transmission unit 517.

The transmission unit 517 acquires the code from the encoding unit 515. The transmission unit 517 transmits the acquired code to the estimation device 53. The transmission unit 517 may transmit the code to the estimation device 53 via a wire such as a cable, or may transmit the code to the estimation device 53 via wireless communication. For example, the transmission unit 517 is configured to transmit a code to the estimation device 53 via a wireless communication function (not illustrated) conforming to a standard such as Bluetooth (registered trademark) or WiFi (registered trademark). The communication function of the transmission unit 517 may conform to a standard other than Bluetooth (registered trademark) or WiFi (registered trademark). The transmission unit 517 also has a function of receiving data transmitted from the estimation device 53. For example, the transmission unit 517 receives update data of model parameters, universal time data, and the like from the estimation device 53. The transmission unit 517 outputs the received data to the control unit 513.

### [Estimation Device]

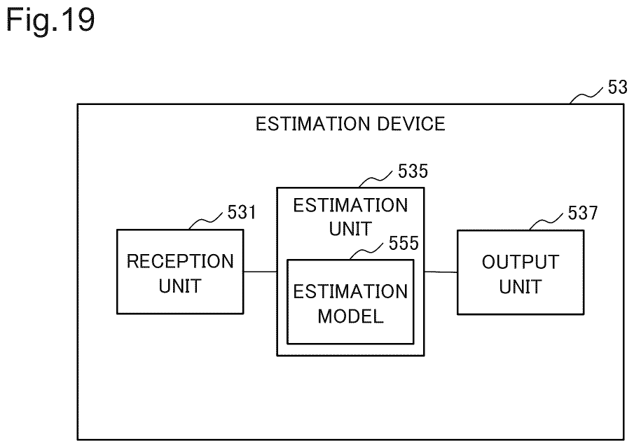

Next, a detailed configuration of the estimation device 53 included in the estimation system 50 will be described with reference to the drawings. FIG. 19 is a block diagram illustrating an example of a configuration of the estimation device 53. The estimation device 53 includes a reception unit 531, an estimation unit 535, and an output unit 537.

The reception unit 531 receives a code from the measurement device 51. The reception unit 531 outputs the received code to the estimation unit 535. For example, the reception unit 531 receives a code from the measurement device 51 via wireless communication. For example, the reception unit 531 is configured to receive a code from the measurement device 51 via a wireless communication function (not illustrated) conforming to a standard such as Bluetooth (registered trademark) or WiFi (registered trademark). The communication function of the reception unit 531 may conform to a standard other than Bluetooth (registered trademark) or WiFi (registered trademark). For example, the reception unit 531 may receive the code from the measurement device 51 via a wire such as a cable. The reception unit 531 also has a function of transmitting data to the measurement device 51. For example, the reception unit 531 transmits update data of model parameters, universal time data, and the like to the measurement device 51.

The estimation unit 535 acquires the code from the reception unit 531. The estimation unit 535 includes an estimation model 555. The estimation model 555 is an estimation model constructed by the training device of the first or third example embodiment. For example, the model parameter set by the training device according to the first or third example embodiment is set in the estimation model 555. The estimation unit 535 inputs the acquired code to the estimation model 555 to output an estimation result based on the original sensor data (raw data) of the code. For example, the estimation unit 535 estimates a score regarding the gait of the user. For example, the score is a value obtained by indexing the evaluation regarding the gait of the user. For example, the estimation unit 535 estimates the physical condition of the user. For example, the physical condition includes the degree of pronation/supination of the foot, the degree of progression of hallux valgus, the degree of progression of gonarthritis, muscle strength, balance ability, flexibility of the body, and the like. The estimation process by the estimation unit 535 is not particularly limited as long as it is the estimation process related to the gait. The estimation unit 535 outputs the estimation result to the output unit 537.

The output unit 537 acquires the estimation result by the estimation unit 535. The output unit 537 outputs the estimation result by the estimation unit 535. For example, the output unit 537 outputs the estimation result by the estimation unit 535 to a display device (not illustrated). For example, the estimation result by the estimation unit 535 is displayed on the screen of the display device. For example, the estimation result by the estimation unit 535 is output to a system that uses the estimation result. The use of the estimation result by the estimation unit 535 is not particularly limited.

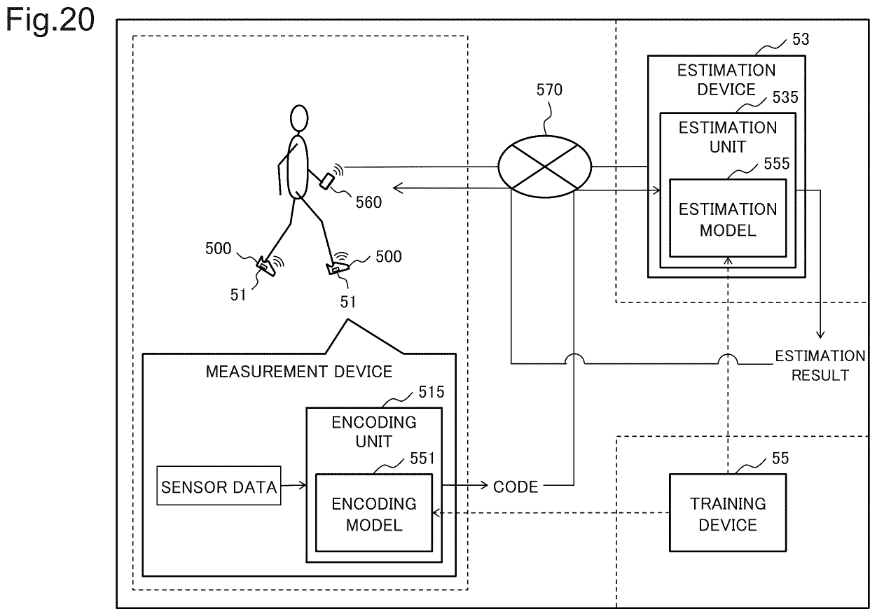

FIG. 20 is a conceptual diagram for explaining processing by the estimation system 50. In the example of FIG. 20, the estimation device 53 and the training device 55 are mounted in a cloud or a server. FIG. 20 illustrates a state in which the user walks carrying a mobile terminal 560. The measurement device 51 is installed at each of the shoe 500 worn by the user. The measurement device 51 is wirelessly connected to the mobile terminal 560. The mobile terminal 560 is connected to an estimation device 53 mounted in a cloud or a server via a network 570. A training device 55 similar to the training device of the first or third example embodiment is mounted in a cloud or a server. For example, the training device 55 transmits update data of the model parameter to the measurement device 51 and the estimation device 53 at a timing of setting the model parameter such as at the time of initial setting or at the time of update.

The measurement device 51 measures sensor data regarding the motion of the foot such as the acceleration and the angular velocity as the user walks. The encoding unit 515 of the measurement device 51 inputs the measured sensor data to the encoding model 551 and encodes the sensor data. The measurement device 51 transmits a code obtained by encoding the sensor data to the mobile terminal 560. The code transmitted from the measurement device 51 is transmitted to the estimation device 53 via the mobile terminal 560 carried by the user and the network 570. When acquiring the update data of the model parameter of the encoding model 551 from the training device 55, the measurement device 51 updates the model parameter of the encoding model 551.

The estimation device 53 receives a code from the measurement device 51 via the network 570. The estimation unit 535 of the estimation device 53 performs estimation by inputting the received code to the estimation model 555. The estimation device 53 outputs an estimation result by the estimation model 555. The estimation result output from the estimation device 53 is transmitted to the mobile terminal 560 carried by the user via the network 570. When acquiring the update data of the model parameter of the estimation model 555 from the training device 55, the estimation device 53 updates the model parameter of the estimation model 555.

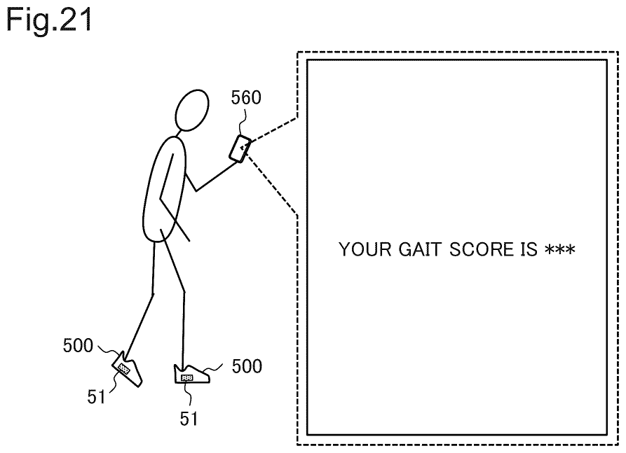

FIG. 21 illustrates an example in which the information about the estimation result by the estimation device 53 is displayed on the screen of the mobile terminal 560 carried by the user. In the example of FIG. 21, an estimation result of “your gait score is ***” is displayed on the screen of the mobile terminal 560. The user who has viewed the screen of the mobile terminal 560 can recognize the score regarding his/her gait. The screen is not limited to the screen of the mobile terminal 560 as long as it is a screen with which the estimation result by the estimation device 53 can be visually recognizable by the user, and may be a screen of a stationary personal computer or a dedicated terminal. The estimation result by the estimation device 53 may be an image representing the estimation result instead of textual information. The estimation result by the estimation device 53 may be notified in a preset pattern of sound, vibration, or the like.

### (Operation)

Next, an operation of the estimation system 50 of the present embodiment will be described with reference to the drawings. Hereinafter, the operations of the measurement device 51 and the estimation device 53 will be individually described.

### [Measurement Device]

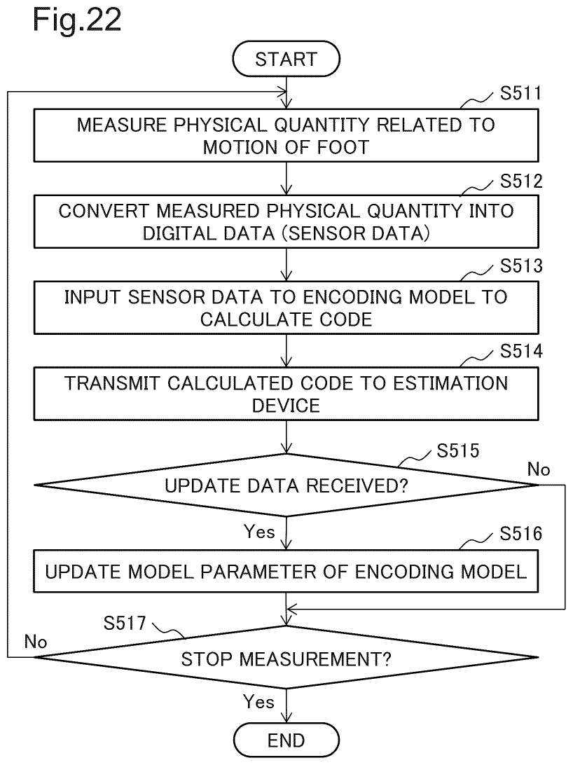

FIG. 22 is a flowchart for explaining an example of the operation of the measurement device 51. In the description along the flowchart of FIG. 22, the measurement device 51 will be described as an operation subject.

In FIG. 22, first, the measurement device 51 measures a physical quantity related to the motion of the foot (step S511). For example, the physical quantity related to the motion of the foot is an acceleration in each of the three axis directions and an angular velocity around each of the three axes.

Next, the measurement device 51 converts the measured physical quantity into digital data (sensor data) (step S512).

Next, the measurement device 51 inputs sensor data (raw data) to the encoding model 551 to calculate a code (step S513).

Next, the measurement device 51 transmits the calculated code to the estimation device 53 (step S514).

When receiving the update data (Yes in step S515), the measurement device 51 updates the model parameter of the encoding model 551 (step S516). When the update data is not received (No in step S515), the process proceeds to step S517 without updating the model parameter of the encoding model 551.

When the measurement is stopped (Yes in step S517), the process according to the flowchart of FIG. 22 is ended. The measurement may be stopped at a preset timing, or may be stopped according to an operation by the user. When the measurement is not stopped (No in step S517), the process returns to step S511.

### [Measurement Device]

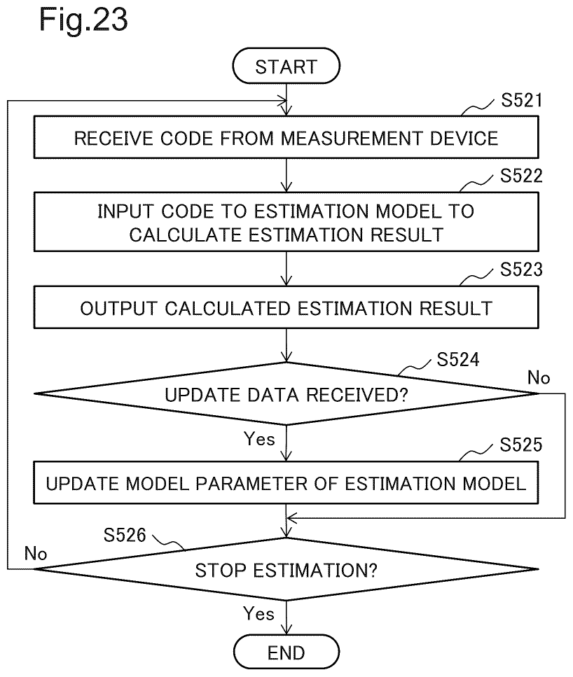

FIG. 23 is a flowchart for explaining an example of the operation of the estimation device 53. In the description along the flowchart of FIG. 23, the estimation device 53 will be described as an operation subject.

In FIG. 23, first, the estimation device 53 receives a code from the measurement device 51 (step S521).

Next, the estimation device 53 inputs the code to the estimation model 555 and calculates an estimation result (step S522).

Next, the estimation device 53 outputs the calculated estimation result (step S523).

When receiving the update data (Yes in step S524), the estimation device 53 updates the model parameter of the estimation model 555 (step S525). When the update data is not received (No in step S524), the process proceeds to step S526 without updating the model parameter of the estimation model 555.

When the estimation is stopped (Yes in step S526), the process according to the flowchart in FIG. 23 is ended. The estimation may be stopped at a preset timing, or may be stopped according to an operation by the user. When the estimation is not stopped (No in step S526), the process returns to step S521.

As described above, the estimation system of the present embodiment includes the measurement device and the estimation device. The measurement device includes the encoding model constructed by the training device of the first or third example embodiment and at least one measurement instrument. The measurement device inputs raw data measured by the measurement instrument to the encoding model. The measurement device transmits, to the estimation device, the code output from the encoding model in response to an input of the raw data. The estimation device includes an estimation model constructed by the training device of the first or third example embodiment. The estimation device receives the code transmitted from the measurement device. The estimation device inputs the received code to the estimation model. The estimation device outputs the estimation result output from the estimation model in response to an input of the code.

In the present embodiment, the encoding model constructed by the training device of the first or third example embodiment is implemented in the measurement device, and the estimation model constructed by the training device of the first or third example embodiment is implemented in the estimation device. According to the present embodiment, since the code encoded by the encoding model is transmitted, the amount of data in communication can be reduced. According to the present embodiment, by using the encoding model and the estimation model trained based on the relationship between the code and the feature amount, it is possible to perform estimation with high accuracy while correctly grasping the causal relationship. That is, according to the present embodiment, by using the encoding model and the estimation model trained based on the relationship between the code and the feature amount, it is possible to construct a model that performs estimation with high accuracy while correctly grasping the causal relationship using the code obtained by reducing the dimension of the raw data.

In an aspect of the present embodiment, the measurement device is worn by the user and measures sensor data (raw data) regarding the motion of the user. The measurement device transmits, to the estimation device, the code output from the encoding model in response to an input of the measured sensor data. The estimation device receives the code transmitted from the measurement device. The estimation device transmits information related to an estimation result to a mobile terminal having a display unit with which the estimation result can be visually recognizable by the user. For example, the information about the estimation result transmitted to the portable device is displayed on the display unit of the mobile terminal. The user who has visually recognized the information about the estimation result displayed on the display unit of the mobile terminal can recognize the estimation result.

### Sixth Example Embodiment

Next, an estimation system according to a sixth example embodiment will be described with reference to the drawings. The estimation system of the present embodiment includes the encoding model and the estimation model constructed by the training device of the second example embodiment. The present embodiment is different from the fifth example embodiment in that a feature amount is calculated using sensor data, and estimation is performed using the calculated feature amount and a code related to the feature amount.

### (Configuration)

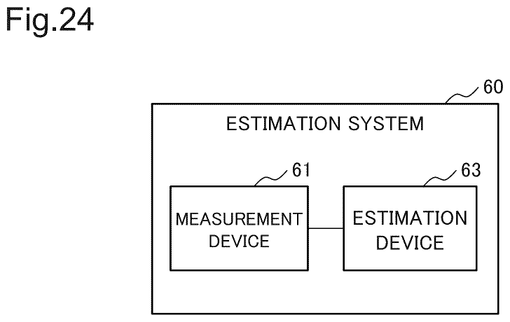

FIG. 24 is a block diagram illustrating an example of a configuration of an estimation system 60 of the present embodiment. The estimation system 60 includes a measurement device 61 and an estimation device 63. The measurement device 61 and the estimation device 63 may be connected by wire or wirelessly. The measurement device 61 and the estimation device 63 may be configured by a single device. The arrangement of the measurement device 61 and the estimation device 63 is similar to that of the fifth example embodiment. Hereinafter, the same points as those of the fifth example embodiment may be omitted.

### [Measurement Device]

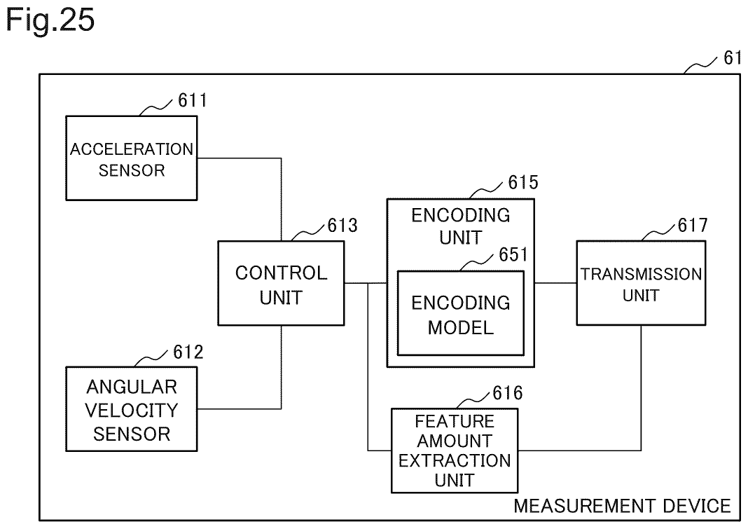

FIG. 25 is a block diagram illustrating an example of a detailed configuration of the measurement device 61. The measurement device 61 includes an acceleration sensor 611, an angular velocity sensor 612, a control unit 613, an encoding unit 615, a feature amount extraction unit 616, and a transmission unit 617. The measurement device 61 includes a real-time clock and a power supply (not illustrated).

The acceleration sensor 611 has a configuration similar to that of the acceleration sensor 511 of the fifth example embodiment. The acceleration sensor 611 measures accelerations in the three axis directions (also referred to as spatial accelerations). The acceleration sensor 611 outputs the measured acceleration to the control unit 613.

The angular velocity sensor 612 has a configuration similar to that of the angular velocity sensor 512 of the fifth example embodiment. The angular velocity sensor 612 measures angular velocities in the three axis directions (also referred to as spatial angular velocities). The angular velocity sensor 612 outputs the measured angular velocity to the control unit 613.

The control unit 613 has a configuration similar to that of the control unit 513 of the fifth example embodiment. The control unit 613 acquires the acceleration in each of the three axis directions and the angular velocity around each of the three axes from each of the acceleration sensor 611 and the angular velocity sensor 612. The control unit 613 converts the acquired acceleration and angular velocity into digital data to output the converted digital data (also referred to as sensor data) to the encoding unit 615 and the feature amount extraction unit 616.

The encoding unit 615 acquires sensor data from the control unit 613. The encoding unit 615 includes an encoding model 651. The encoding model 651 is an encoding model constructed by the training device of the second example embodiment. For example, the model parameter set by the training device of the second example embodiment is set in the encoding model 651. The encoding unit 615 inputs the acquired sensor data to the encoding model 651 and encodes the sensor data. The encoding unit 615 outputs a code obtained by encoding the sensor data to the transmission unit 617.

The feature amount extraction unit 616 has a configuration similar to that of the feature amount calculation unit 12 of the first example embodiment. The feature amount extraction unit 616 acquires sensor data from the control unit 613. The feature amount extraction unit 616 calculates a feature amount using the acquired sensor data. The feature amount extraction unit 616 outputs the calculated feature amount to the transmission unit 617.

The transmission unit 617 has a configuration similar to that of the transmission unit 517 of the fifth example embodiment. The transmission unit 617 acquires the code from the encoding unit 615. The transmission unit 617 acquires the feature amount from the feature amount extraction unit 616. The transmission unit 617 transmits the acquired code and feature amount to the estimation device 63.

### [Estimation Device]

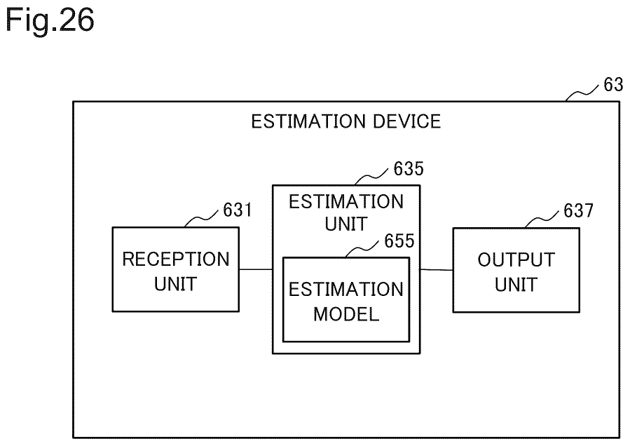

FIG. 26 is a block diagram illustrating an example of a configuration of the estimation device 63. The estimation device 63 includes a reception unit 631, an estimation unit 635, and an output unit 637.

The reception unit 631 has a configuration similar to that of the reception unit 531 of the fifth example embodiment. The reception unit 631 receives the code and the feature amount from the measurement device 61. The reception unit 631 outputs the received code and feature amount to the estimation unit 635.

The estimation unit 635 acquires the code and the feature amount from the reception unit 631. The estimation unit 635 includes an estimation model 655. The estimation model 655 is an estimation model constructed by the training device of the second example embodiment. For example, the model parameter set by the training device of the second example embodiment is set in the estimation model 655. The estimation unit 635 inputs the acquired code and feature amount to the estimation model 655 to output an estimation result based on the original sensor data (raw data) of the code. For example, the estimation unit 635 estimates a score regarding the gait of the user. For example, the score is a value obtained by indexing the evaluation regarding the gait of the user. For example, the estimation unit 635 estimates the physical condition of the user. For example, the physical condition includes the degree of pronation/supination of the foot, the degree of progression of hallux valgus, the degree of progression of gonarthritis, muscle strength, balance ability, flexibility of the body, and the like. The estimation process by the estimation unit 635 is not particularly limited as long as it is the estimation process related to the gait. The estimation unit 635 outputs the estimation result to the output unit 637.

The output unit 637 has the similar configuration as the output unit 537 of the fifth example embodiment. The output unit 637 acquires the estimation result by the estimation unit 635. The output unit 637 outputs the estimation result by the estimation unit 635.

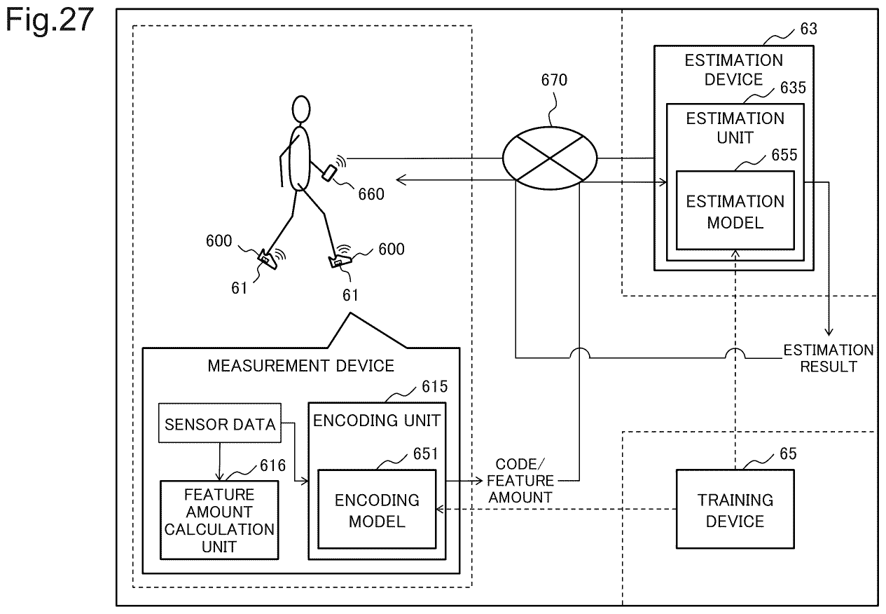

FIG. 27 is a conceptual diagram for explaining processing by the estimation system 60. In the example of FIG. 27, the estimation device 63 and a training device 65 are implemented in a cloud or a server. FIG. 27 illustrates a state in which the user walks carrying the mobile terminal 660. The measurement device 61 is installed at each of the shoe 600 worn by the user. The measurement device 61 is wirelessly connected to a mobile terminal 660. The mobile terminal 660 is connected to the estimation device 63 mounted in a cloud or a server via a network 670. The training device 65 similar to the training device of the second example embodiment is mounted in a cloud or a server. For example, the training device 65 transmits update data of the model parameter to the measurement device 61 and the estimation device 63 at a timing of setting the model parameter such as at the time of initial setting or at the time of update.

The measurement device 61 measures sensor data regarding the motion of the foot such as the acceleration and the angular velocity as the user walks. The encoding unit 615 of the measurement device 61 inputs the measured sensor data to the encoding model 651 and encodes the sensor data. The feature amount extraction unit 616 of the measurement device 61 calculates a feature amount using the sensor data. The measurement device 61 transmits the code obtained by encoding the sensor data and the feature amount to the mobile terminal 660. The code and the feature amount transmitted from the measurement device 61 are transmitted to the estimation device 63 via the mobile terminal 660 carried by the user and the network 670. When acquiring the update data of the model parameter of the encoding model 651 from the training device 65, the measurement device 61 updates the model parameter of the encoding model 651.

The estimation device 63 receives the code and the feature amount from the measurement device 61 via the network 670. The estimation unit 635 of the estimation device 63 performs estimation by inputting the received code and feature amount to the estimation model 655. The estimation device 63 outputs an estimation result by the estimation model 655. The estimation result output from the estimation device 63 is transmitted to the mobile terminal 660 carried by the user via the network 670. When acquiring the update data of the model parameter of the estimation model 655 from the training device 65, the estimation device 63 updates the model parameter of the estimation model 655.

### (Operation)

Next, an operation of the estimation system 60 of the present embodiment will be described with reference to the drawings. Hereinafter, the operations of the measurement device 61 and the estimation device 63 will be individually described.

### [Measurement Device]

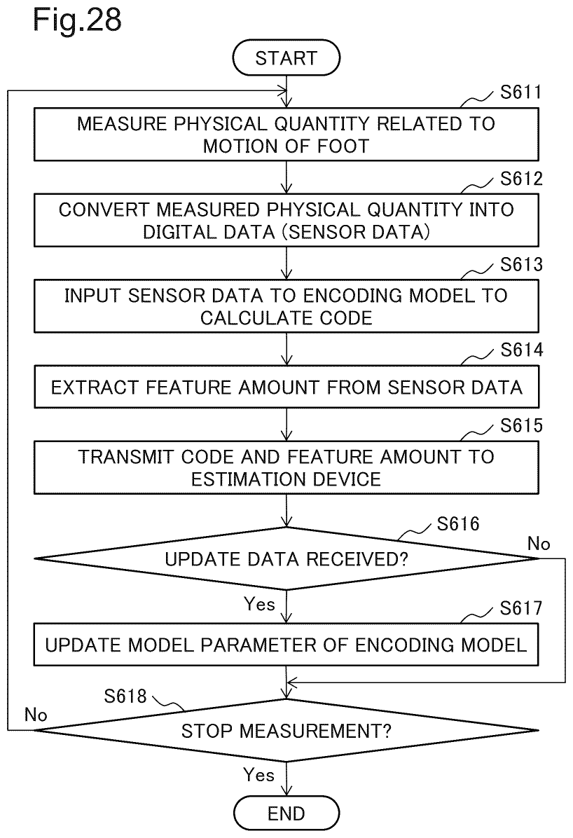

FIG. 28 is a flowchart for explaining an example of the operation of the measurement device 61. In the description along the flowchart of FIG. 28, the measurement device 61 will be described as an operation subject.

In FIG. 28, first, the measurement device 61 measures a physical quantity related to the motion of the foot (step S611). For example, the physical quantity related to the motion of the foot is an acceleration in each of the three axis directions and an angular velocity around each of the three axes.

Next, the measurement device 61 converts the measured physical quantity into digital data (sensor data) (step S612).

Next, the measurement device 61 inputs sensor data (raw data) to the encoding model 651 to calculate a code (step S613).

Next, the measurement device 61 extracts a feature amount from the sensor data (step S614). Steps S613 and S614 may be executed in a switched order, or may be executed in parallel.

Next, the measurement device 61 transmits the code and the feature amount to the estimation device 63 (step S615).

When receiving the update data (Yes in step S616), the measurement device 61 updates the model parameter of the encoding model 651 (step S617). When the update data is not received (No in step S616), the process proceeds to step S618 without updating the model parameter of the encoding model 651.

When the measurement is stopped (Yes in step S618), the process according to the flowchart of FIG. 28 is ended. The measurement may be stopped at a preset timing, or may be stopped according to an operation by the user. When the measurement is not stopped (No in step S618), the process returns to step S611.

### [Measurement Device]

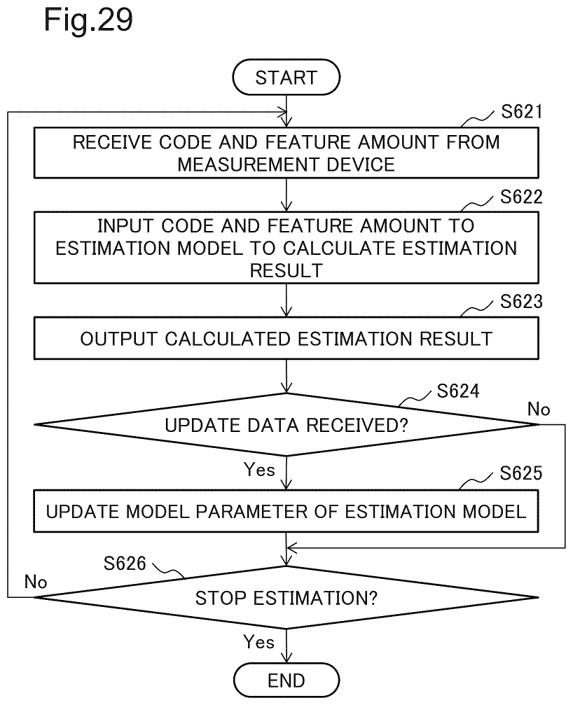

FIG. 29 is a flowchart for explaining an example of the operation of the estimation device 63. In the description along the flowchart of FIG. 29, the estimation device 63 will be described as an operation subject.

In FIG. 29, first, the estimation device 63 receives the code and the feature amount from the measurement device 61 (step S621).

Next, the estimation device 63 inputs the code and the feature amount to the estimation model 655 and calculates an estimation result (step S622).

Next, the estimation device 63 outputs the calculated estimation result (step S623).

When receiving the update data (Yes in step S624), the estimation device 63 updates the model parameter of the estimation model 655 (step S625). When the update data is not received (No in step S624), the process proceeds to step S626 without updating the model parameter of the estimation model 655.

When the estimation is stopped (Yes in step S626), the process according to the flowchart in FIG. 29 is ended. The estimation may be stopped at a preset timing, or may be stopped according to an operation by the user. When the estimation is not stopped (No in step S626), the process returns to step S621.

As described above, the estimation system of the present embodiment includes the measurement device and the estimation device. The measurement device includes the encoding model constructed by the training device of the second example embodiment and at least one measurement instrument. The measurement device calculates the feature amount using the raw data. The measurement device inputs raw data measured by the measurement instrument to the encoding model. The measurement device transmits, to the estimation device, the code output from the encoding model in response to an input of the raw data and the feature amount calculated using the raw data. The estimation device includes an estimation model constructed by the training device of the second example embodiment. The estimation device receives the code and the feature amount transmitted from the measurement device. The estimation device inputs the received code and feature amount to the estimation model. The estimation device outputs the estimation result output from the estimation model in response to an input of the code.

In the present embodiment, the encoding model constructed by the training device of the second example embodiment is implemented in the measurement device, and the estimation model constructed by the training device of the second example embodiment is implemented in the estimation device. According to the present embodiment, as in the fifth example embodiment, by using the encoding model and the estimation model trained based on the relationship between the code and the feature amount, it is possible to perform estimation with high accuracy while correctly grasping the causal relationship. According to the present embodiment, since the estimation is performed using the feature amount in addition to the code, it is possible to perform estimation with high accuracy as compared with the fifth example embodiment.

### Seventh Example Embodiment

Next, an estimation system according to a seventh example embodiment will be described with reference to the drawings. The estimation system of the present embodiment includes the encoding model, the reconstruction model, and the estimation model constructed by the training device of the first example embodiment. The present embodiment is different from the fifth example embodiment in that estimation is performed using a reconstructed feature amount reconstructed by a reconstruction model.

### (Configuration)

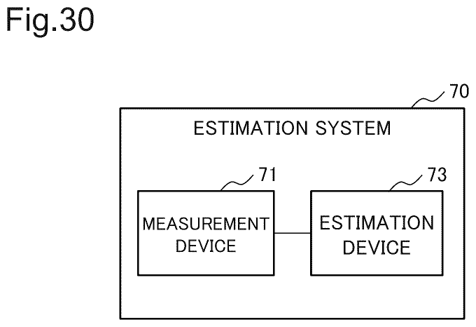

FIG. 30 is a block diagram illustrating an example of a configuration of an estimation system 70 of the present embodiment. The estimation system 70 includes a measurement device 71 and an estimation device 73. The measurement device 71 and the estimation device 73 may be connected by wire or wirelessly. The measurement device 71 and the estimation device 73 may be configured by a single device. The arrangement of the measurement device 71 and the estimation device 73 is similar to that of the fifth example embodiment. Hereinafter, the same points as those of the fifth example embodiment may be omitted.

### [Measurement Device]

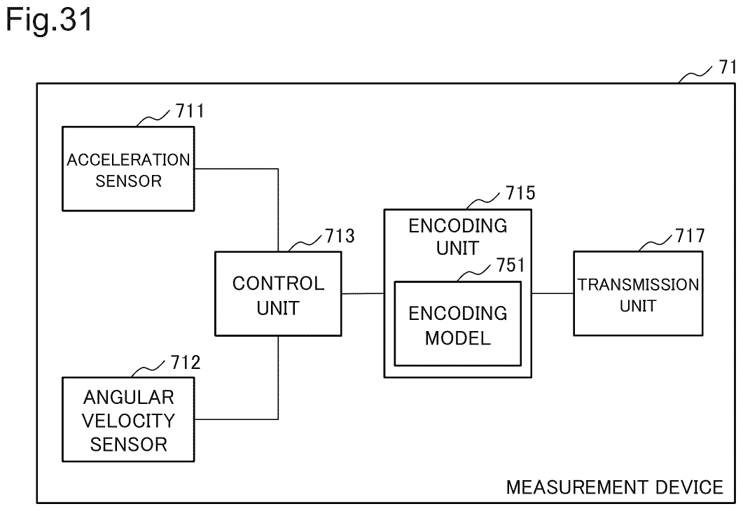

FIG. 31 is a block diagram illustrating an example of a detailed configuration of the measurement device 71. The measurement device 71 includes an acceleration sensor 711, an angular velocity sensor 712, a control unit 713, an encoding unit 715, and a transmission unit 717. The measurement device 71 includes a real-time clock and a power supply (not illustrated).

The acceleration sensor 711 has a configuration similar to that of the acceleration sensor 511 of the fifth example embodiment. The acceleration sensor 711 measures accelerations in the three axis directions (also referred to as spatial accelerations). The acceleration sensor 711 outputs the measured acceleration to the control unit 713.

The angular velocity sensor 712 has a configuration similar to that of the angular velocity sensor 512 of the fifth example embodiment. The angular velocity sensor 712 measures angular velocities in the three axis directions (also referred to as spatial angular velocities). The angular velocity sensor 712 outputs the measured angular velocity to the control unit 713.

The control unit 713 has a configuration similar to that of the control unit 513 of the fifth example embodiment. The control unit 713 acquires the acceleration in each of the three axis directions and the angular velocity around each of the three axes from each of the acceleration sensor 711 and the angular velocity sensor 712. The control unit 713 converts the acquired acceleration and angular velocity into digital data to output the converted digital data (also referred to as sensor data) to the encoding unit 715.

The encoding unit 715 acquires sensor data from the control unit 713. The encoding unit 715 includes an encoding model 751. The encoding model 751 is an encoding model constructed by the training device of the first example embodiment (the first modification). For example, the model parameter set by the training device of the first example embodiment (first modification) is set in the encoding model 751. The encoding unit 715 inputs the acquired sensor data to the encoding model 751 and encodes the sensor data. The encoding unit 715 outputs a code obtained by encoding the sensor data to the transmission unit 717.

The transmission unit 717 has a configuration similar to that of the transmission unit 517 of the fifth example embodiment. The transmission unit 717 acquires the code from the encoding unit 715. The transmission unit 717 transmits the acquired code to the estimation device 73.

### [Estimation Device]

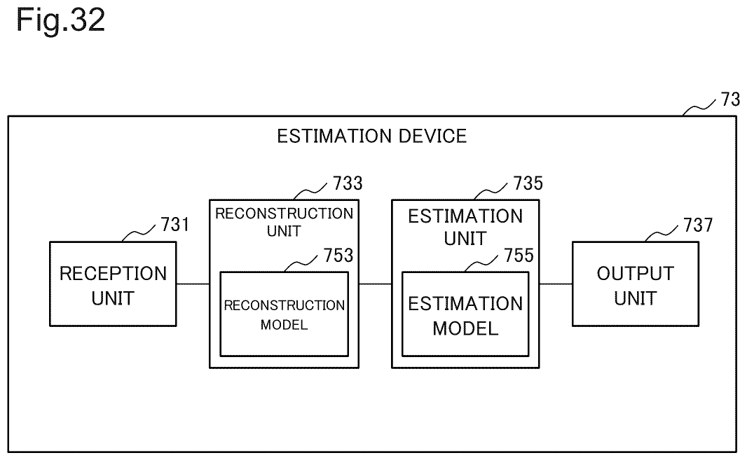

FIG. 32 is a block diagram illustrating an example of a configuration of the estimation device 73. The estimation device 73 includes a reception unit 731, a reconstruction unit 733, an estimation unit 735, and an output unit 737.

The reception unit 731 has a configuration similar to that of the reception unit 531 of the fifth example embodiment. The reception unit 731 receives a code from the measurement device 71. The reception unit 731 outputs the received code to the reconstruction unit 733.

The reconstruction unit 733 acquires the code from the reception unit 731. The reconstruction unit 733 includes a reconstruction model 753. The reconstruction model 753 is an estimation model constructed by the training device of the first example embodiment (first modification). For example, the model parameter set by the training device of the first example embodiment (modification) is set in the reconstruction model 753. The reconstruction unit 733 inputs the acquired code to the reconstruction model 753 and calculates the reconstructed feature amount. The reconstruction unit 733 outputs the calculated reconstructed feature amount to the estimation model 755.

The estimation unit 735 acquires the reconstructed feature amount from the reconstruction unit 733. The estimation unit 735 includes an estimation model 755. The estimation model 755 is an estimation model constructed by the training device of the first example embodiment (first modification). For example, the model parameter set by the training device of the first example embodiment (first modification) is set in the estimation model 755. The estimation unit 735 inputs the acquired reconstructed feature amount to the estimation model 755 to output an estimation result based on original sensor data (raw data) of the reconstructed feature amount. For example, the estimation unit 735 estimates a score regarding the gait of the user. For example, the score is a value obtained by indexing the evaluation regarding the gait of the user. For example, the estimation unit 735 estimates the physical condition of the user. For example, the physical condition includes the degree of pronation/supination of the foot, the degree of progression of hallux valgus, the degree of progression of gonarthritis, muscle strength, balance ability, flexibility of the body, and the like. The estimation process by the estimation unit 735 is not particularly limited as long as it is the estimation process related to the gait. The estimation unit 735 outputs the estimation result to the output unit 637.

The output unit 737 has a configuration similar to that of the output unit 537 of the fifth example embodiment. The output unit 737 acquires the estimation result by the estimation unit 735. The output unit 737 outputs the estimation result by the estimation unit 735.

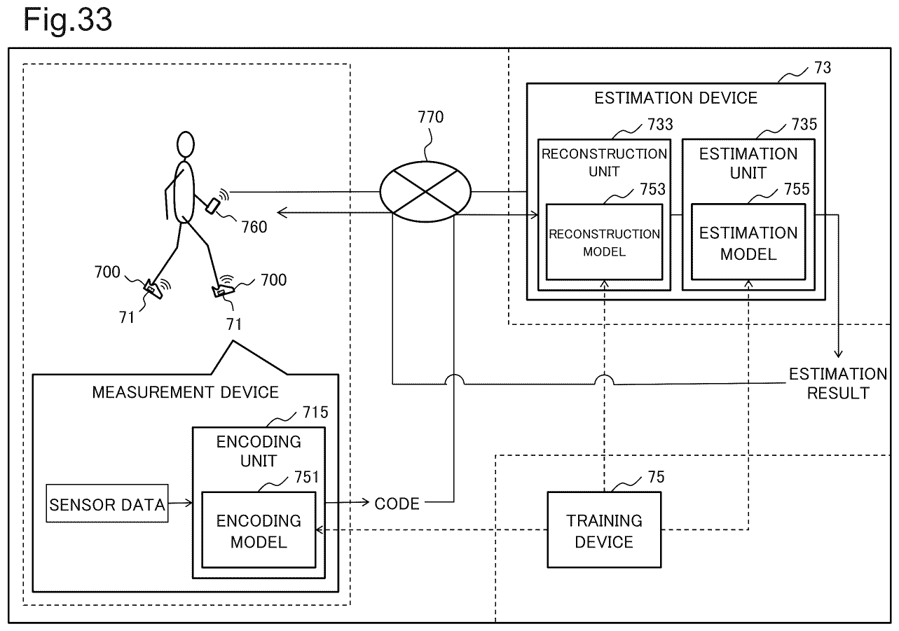

FIG. 33 is a conceptual diagram for explaining processing by the estimation system 70. In the example of FIG. 33, the estimation device 73 and a training device 75 are implemented in a cloud or a server. FIG. 33 illustrates a state in which the user walks carrying a mobile terminal 760. The measurement device 71 is installed at each of the shoe 700 worn by the user. The measurement device 71 is wirelessly connected to the mobile terminal 760. The mobile terminal 760 is connected to the estimation device 73 mounted in a cloud or a server via a network 770. The training device 75 similar to the training device of the first example embodiment (first modification) is mounted in a cloud or a server. For example, the training device 75 transmits update data of the model parameter to the measurement device 71 and the estimation device 73 at a timing of setting the model parameter such as at the time of initial setting or at the time of update.

The measurement device 71 measures sensor data regarding the motion of the foot such as the acceleration and the angular velocity as the user walks. The encoding unit 715 of the measurement device 71 inputs the measured sensor data to the encoding model 751 and encodes the sensor data. The measurement device 61 transmits a code obtained by encoding the sensor data to the mobile terminal 760. The code transmitted from the measurement device 71 is transmitted to the estimation device 73 via the mobile terminal 760 carried by the user and the network 770. When acquiring the update data of the model parameter of the encoding model 751 from the training device 75, the measurement device 71 updates the model parameter of the encoding model 751.

The estimation device 73 receives a code from the measurement device 71 via the network 770. The reconstruction unit 733 of the estimation device 73 inputs the received code to the reconstruction model 753 to calculate the reconstructed feature amount. The estimation unit 735 of the estimation device 73 performs estimation by inputting the reconstructed feature amount calculated by the reconstruction unit 733 to the estimation model 755. The estimation device 73 outputs an estimation result. The estimation result output from the estimation device 73 is transmitted to the mobile terminal 760 carried by the user via the network 770. When acquiring the update data of the model parameters of the reconstruction model 753 and the estimation model 755 from the training device 75, the estimation device 73 updates the model parameters of the reconstruction model 753 and the estimation model 755.

### (Operation)

Next, an operation of the estimation system 70 of the present embodiment will be described with reference to the drawings. Hereinafter, the operations of the measurement device 71 and the estimation device 73 will be individually described.

### [Measurement Device]

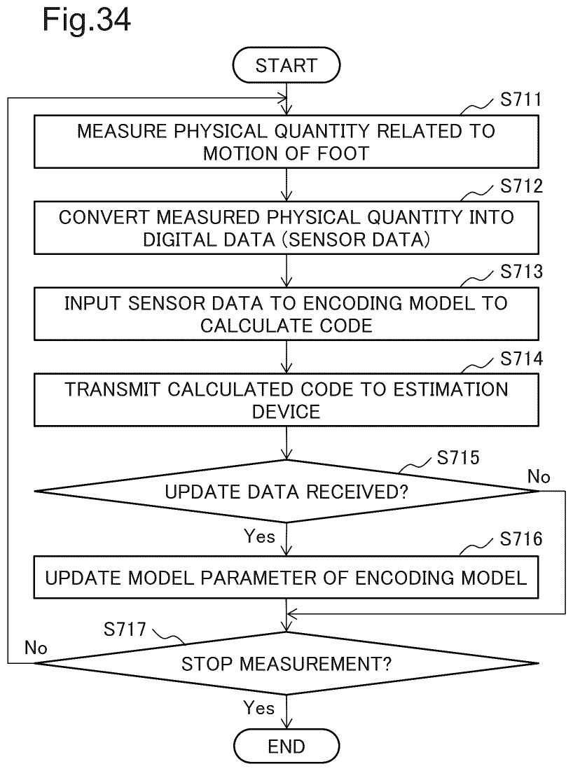

FIG. 34 is a flowchart for explaining an example of the operation of the measurement device 71. In the description along the flowchart of FIG. 34, the measurement device 71 will be described as an operation subject.

In FIG. 34, first, the measurement device 71 measures a physical quantity related to the motion of the foot (step S711). For example, the physical quantity related to the motion of the foot is an acceleration in each of the three axis directions and an angular velocity around each of the three axes.

Next, the measurement device 71 converts the measured physical quantity into digital data (sensor data) (step S712).

Next, the measurement device 71 inputs sensor data (raw data) to the encoding model 751 to calculate a code (step S713).

Next, the measurement device 71 transmits the calculated code to the estimation device 73 (step S714).

When receiving the update data (Yes in step S715), the measurement device 71 updates the model parameter of the encoding model 751 (step S716). When the update data is not received (No in step S715), the process proceeds to step S717 without updating the model parameter of the encoding model 751.

When the measurement is stopped (Yes in step S717), the process according to the flowchart of FIG. 34 is ended. The measurement may be stopped at a preset timing, or may be stopped according to an operation by the user. When the measurement is not stopped (No in step S717), the process returns to step S711.

### [Measurement Device]

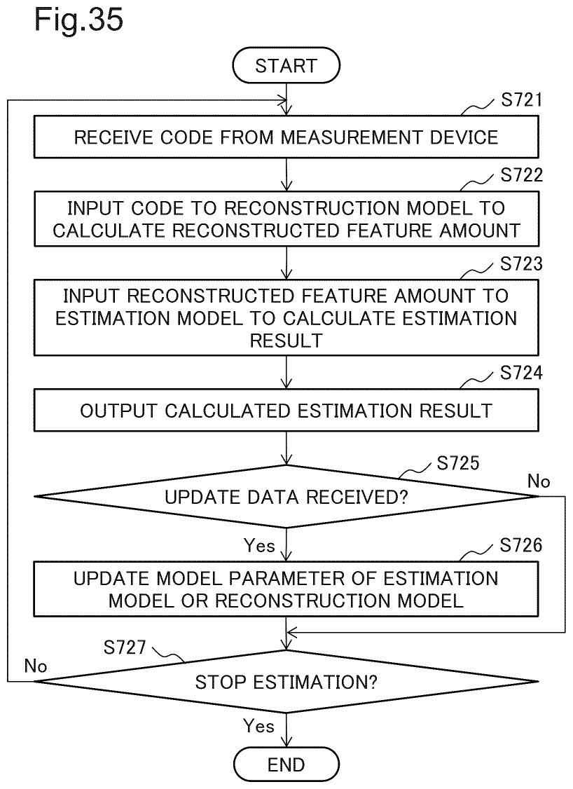

FIG. 35 is a flowchart for explaining an example of the operation of the estimation device 73. In the description along the flowchart of FIG. 35, the estimation device 73 will be described as an operation subject.

In FIG. 35, first, the estimation device 73 receives a code from the measurement device 71 (step S721).

Next, the estimation device 73 inputs the code to the reconstruction model 753 to calculate a reconstructed feature amount (step S722).

Next, the estimation device 73 inputs the reconstructed feature amount to the estimation model 755 and calculates an estimation result (step S723).

Next, the estimation device 73 outputs the calculated estimation result (step S724).

When receiving the update data (Yes in step S725), the estimation device 73 updates the model parameters of the reconstruction model 753 and the estimation model 755 (step S726). When the update data is not received (No in step S725), the process proceeds to step S727 without updating the model parameters of the reconstruction model 753 and the estimation model 755.

When the estimation is stopped (Yes in step S727), the process according to the flowchart in FIG. 35 is ended. The estimation may be stopped at a preset timing, or may be stopped according to an operation by the user. When the estimation is not stopped (No in step S727), the process returns to step S721.

As described above, the estimation system of the present embodiment includes the measurement device and the estimation device. The measurement device includes the encoding model constructed by the training device of the first example embodiment (modification) and at least one measurement instrument (sensor). The measurement device inputs raw data measured by the measurement instrument to the encoding model. The measurement device transmits, to the estimation device, the code output from the encoding model in response to an input of the raw data. The estimation device includes a reconstruction model that outputs a reconstructed feature amount related to an original feature amount of the code in response to an input of the code. The estimation device includes an estimation model that outputs an estimation result related to original raw data of the code in response to an input of the reconstructed feature amount. The estimation device receives the code transmitted from the measurement device. The estimation device inputs the received code to the reconstruction model. The estimation device inputs the reconstructed feature amount output from the reconstruction model in response to an input of the code to the estimation model. The estimation device outputs the estimation result output from the estimation model in response to an input of the reconstructed feature amount.

In the present embodiment, the encoding model constructed by the training device of the first example embodiment (modification) is mounted on the measurement device. The reconstruction model constructed by the training device of the first example embodiment (modification) and the estimation model that outputs an estimation result related to raw data in response to an input of a reconstructed feature amount output by the reconstruction model are implemented in the estimation device. According to the present embodiment, as in the fifth to sixth example embodiments, by using the encoding model and the estimation model trained based on the relationship between the code and the feature amount, it is possible to perform estimation with high accuracy while correctly grasping the causal relationship. According to the present embodiment, since estimation is performed using the reconstructed feature amount reconstructed from the code, it is possible to perform estimation with high accuracy as compared with the fifth example embodiment.

### (Verification Example)

Next, a verification example in which the model constructed by the training device of each example embodiment is verified will be described. In this verification example, the model constructed by the training device according to the first example embodiment is verified using the data set of modified national institute of standards and technology (Fashoin-MNIST). Fashoin-MNIST is a data set disclosed in NPL 1 (NPL 1: H. Xiao, K. Rasul, R. Vollgraf, “Fashion-MNIST: a Novel Image Dataset for Benchmarking Machine Learning Algorithms”, arXiv preprint arXiv:1708.07747 (2017).). Fashoin-MNIST is a data set of clothing images. The data set of Fashoin-MNIST includes an image of 28×28 pixels and a label of the image. The label includes 0 to 9 classes of 10 kinds of clothing. Descriptions of the label and the class are omitted.

In this verification example, the image size of the image (raw data) of 28×28 pixels was converted into a reduced image of 7×7 pixels. The reduced image of 7×7 pixels corresponds to the feature amount of the image (raw data) of 28×28 pixels. The reduced image (feature amount) includes the features of the raw data because the appearance of the image of the raw data remains. The reduced image has a reduced amount of data as compared with the raw data. That is, the reduced image is suitable as a feature amount including knowledge handled in the present disclosure.

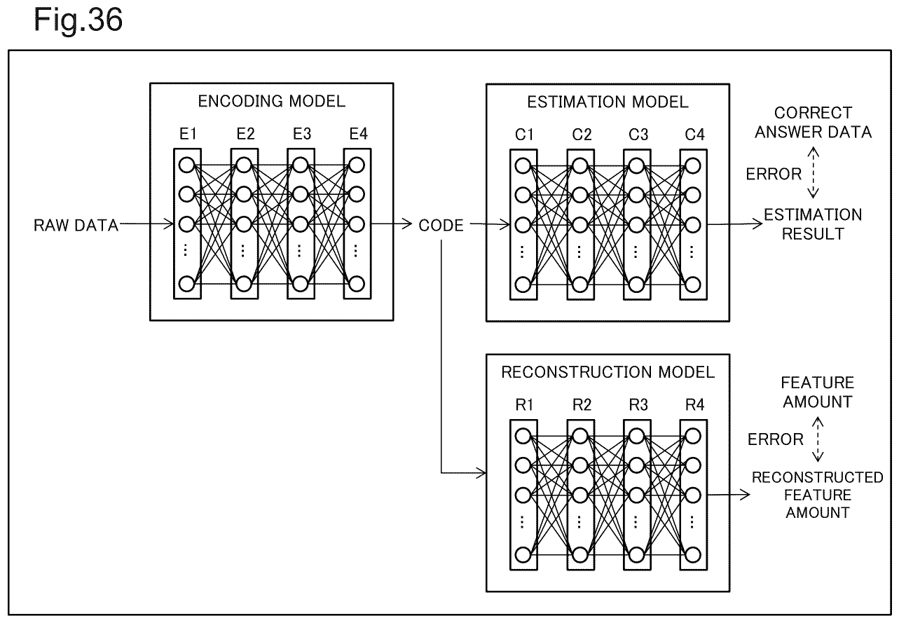

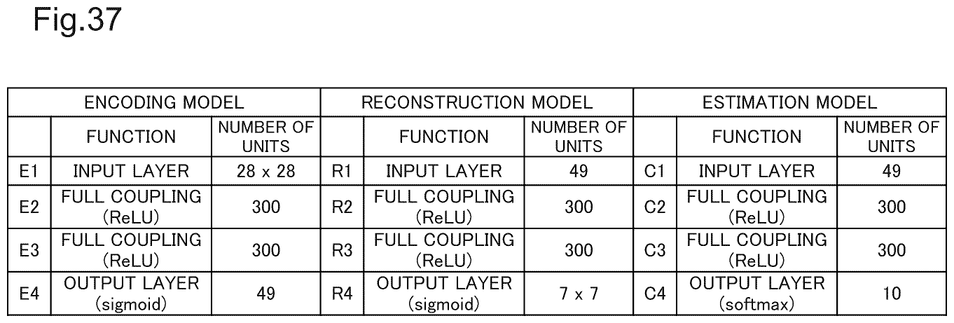

FIG. 36 is a conceptual diagram for explaining the configurations of the encoding model, the reconstruction model, and the estimation model in this verification example. FIG. 37 is a table summarizing details of configurations of the encoding model, the reconstruction model, and the estimation model in this verification example. In this verification example, the encoding model and the reconstruction model were trained in such a way that an error between the reconstruction result (reconstructed feature amount) calculated by the reconstruction model and the feature amount calculated from the original raw data of the reconstructed feature amount was minimized.

The encoding model includes an input layer E1, a first intermediate layer E2, a second intermediate layer E3, and an output layer E4. The number of units of the input layer E1 is 28×28. Raw data of 28×28 (=784) pixels is input to the input layer E1. When raw data of 28×28 pixels is input by 28 pixels at a time, the number of units of the input layer E1 may be 28. The number of units of the first intermediate layer E2 is 300. The activation function of the first intermediate layer E2 is a rectified linear function (ReLU). Each unit of the first intermediate layer E2 is fully coupled to respective units of each of the input layer E1 and the second intermediate layer E3. The number of units of the second intermediate layer E3 is 300. The activation function of the second intermediate layer E3 is a rectified linear function (ReLU). Each unit of the second intermediate layer E3 is fully coupled to respective units of each of the first intermediate layer E2 and the output layer E4. The number of units of the output layer E4 is 49. The activation function of the output layer E4 is sigmoid. The encoding model outputs a code that is a vector having 49 numerical values as elements in response to an input of raw data of 28×28 pixels.

The reconstruction model includes an input layer R1, a first intermediate layer R2, a second intermediate layer R3, and an output layer R4. The number of units of the input layer R1 is 49. A code that is a vector having 49 numerical values as elements is input to the input layer R1. The number of units of the first intermediate layer R2 is 300. The activation function of the first intermediate layer R2 is a rectified linear function (ReLU). Each unit of the first intermediate layer R2 is fully coupled to respective units of each of the input layer R1 and the second intermediate layer R3. The number of units of the second intermediate layer R3 is 300. The activation function of the second intermediate layer R3 is a rectified linear function (ReLU). Each unit of the second intermediate layer R3 is fully coupled to respective units of each of the first intermediate layer R2 and the output layer R4. The number of units of the output layer R4 is 7×7. The activation function of the output layer R4 is sigmoid. In a case where the reconstruction result (reconstructed feature amount) of 7×7 pixels is output by 7 pixels at a time, the number of units of the output layer R4 may be 7. The reconstruction model outputs a reconstruction result (reconstructed feature amount) of 7×7 pixels in response to an input of a code that is a vector having 49 numerical values as elements.

The estimation model includes an input layer C1, a first intermediate layer C2, a second intermediate layer C3, and an output layer C4. The number of units of the input layer C1 is 49. A code that is a vector having 49 numerical values as elements is input to the input layer C1. The number of units of the first intermediate layer C2 is 300. The activation function of the first intermediate layer C2 is a rectified linear function (ReLU). Each unit of the first intermediate layer C2 is fully coupled to respective units of each of the input layer C1 and the second intermediate layer C3. The number of units of the second intermediate layer C3 is 300. The activation function of the second intermediate layer C3 is a rectified linear function (ReLU). Each unit of the second intermediate layer C3 is fully coupled to respective units of each of the first intermediate layer C2 and the output layer C4. The number of units of the output layer C4 is 10. The activation function of the output layer C4 is softmax. The estimation model outputs 10 types of classes as estimation results in response to an input of a code that is a vector having 49 numerical values as elements.

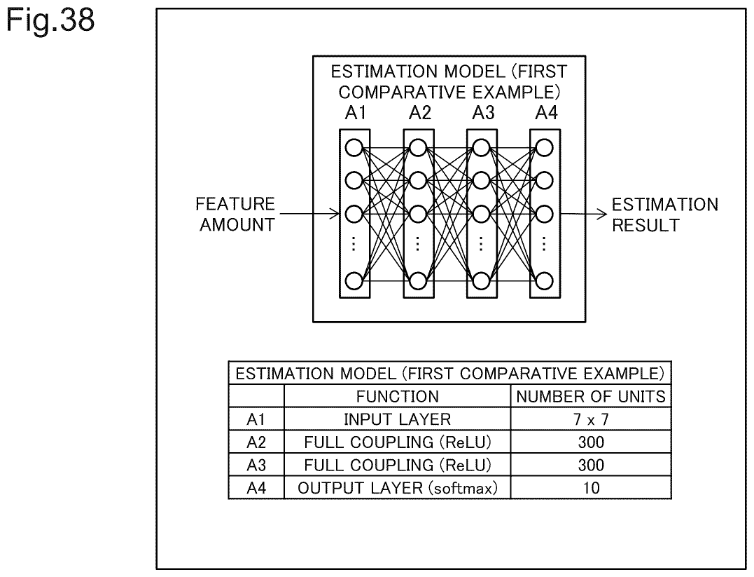

FIG. 38 is a diagram for explaining a configuration of an estimation model of the first comparative example. The estimation model of the first comparative example outputs 10 types of classes as estimation results in response to an input of the feature amount of 7×7 pixels calculated using the raw data of 28×28 pixels. The first comparative example is an example for evaluating the classification accuracy to be achieved at the minimum.

The estimation model of the first comparative example includes an input layer A1, a first intermediate layer A2, a second intermediate layer A3, and an output layer A4. The number of units of the input layer A1 is 7×7. A feature amount of 7×7 (=49) pixels is input to the input layer A1. In a case where the feature amount of 7×7 pixels is input by 7 pixels at a time, the number of units of the input layer A1 may be 7. The number of units of the first intermediate layer A2 is 300. The activation function of the first intermediate layer A2 is a rectified linear function (ReLU). Each unit of the first intermediate layer A2 is fully coupled to respective units of each of the input layer A1 and the second intermediate layer A3. The number of units of the second intermediate layer A3 is 300. The activation function of the second intermediate layer A3 is a rectified linear function (ReLU). Each unit of the second intermediate layer A3 is fully coupled to respective units of each of the first intermediate layer A2 and the output layer A4. The number of units of the output layer A4 is 10. The activation function of the output layer A4 is softmax. The estimation model of the first comparative example outputs 10 types of classes as estimation results in response to an input of the feature amount of 7×7 pixels.

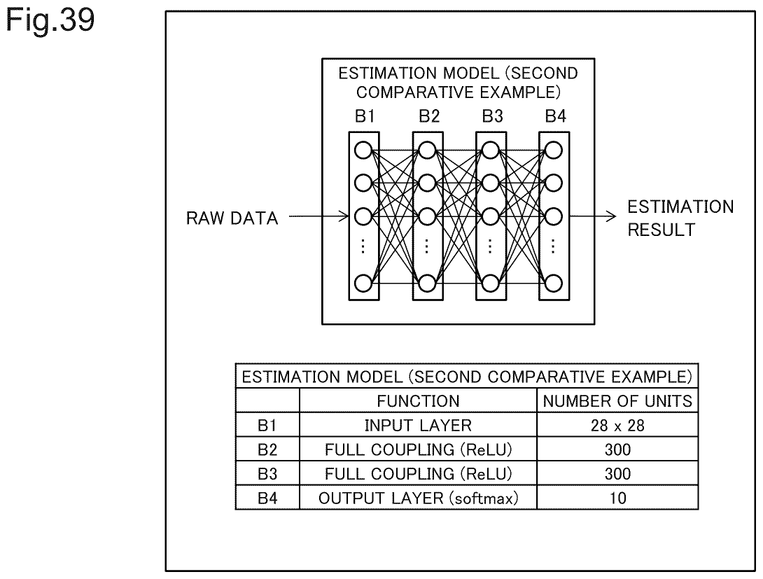

FIG. 39 is a diagram for explaining a configuration of an estimation model of the second comparative example. The estimation model of the second comparative example outputs 10 types of classes as estimation results in response to an input of raw data of 28×28 pixels. The second comparative example is an example for evaluating the expected maximum classification accuracy.

The estimation model of the second comparative example includes an input layer B1, a first intermediate layer B2, a second intermediate layer B3, and an output layer B4. The number of units of the input layer B1 is 28×28. Raw data of 28×28 (=784) pixels is input to the input layer B1. In a case where raw data of 28×28 pixels is input by 28 pixels at a time, the number of units of the input layer B1 may be 28. The number of units of the first intermediate layer B2 is 300. The activation function of the first intermediate layer B2 is a rectified linear function (ReLU). Each unit of the first intermediate layer B2 is fully coupled to respective units of each of the input layer B1 and the second intermediate layer B3. The number of units of the second intermediate layer B3 is 300. The activation function of the second intermediate layer B3 is a rectified linear function (ReLU). Each unit of the second intermediate layer B3 is fully coupled to respective units of each of the first intermediate layer B2 and the output layer B4. The number of units of the output layer B4 is 10. The activation function of the output layer B4 is softmax. The estimation model of the second comparative example outputs 10 types of classes as estimation results in response to an input of the feature amount of 28×28 pixels.

In this verification example, among 70,000 data sets of Fashoin-MNIST, 55000 data sets were set as training data, 5000 data sets were set as verification data, and 10,000 data sets were set as test data. Different data sets were used for the data sets of the training data, the verification data, and the test data. In this verification example, the Adam optimization was used as the optimization algorithm, and the epoch was set to 30 times. As a loss of the estimation result, a multi-class cross entropy error was calculated. As a loss of the reconstruction result (reconstructed feature amount), the mean square error was calculated. In this verification example, the weighted average of the loss of the estimation result and the reconstruction result was used as the loss function. With respect to the weighted average of the loss of the estimation result and the reconstruction result, the weight of the estimation result is denoted by α, and the weight of the reconstruction result is denoted by β. A multi-class cross entropy error function was used as the loss function in the first and second comparative examples. As the evaluation index, a value (classification accuracy) obtained by dividing the total number of test data by the number of correct answers was used.

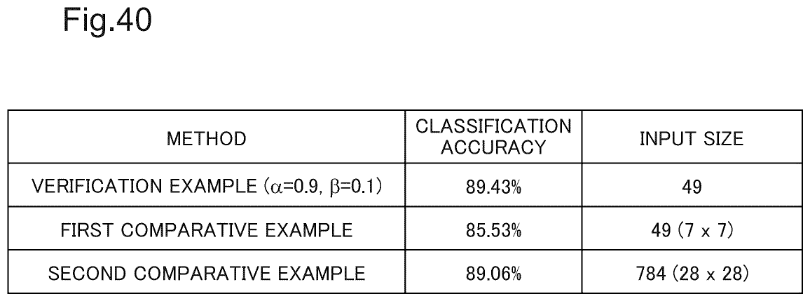

FIG. 40 is a table summarizing classification accuracy of the present verification example and the first and second comparative examples. In this verification example, the weight α of the estimation result was set to 0.9, the weight 3 of the reconstruction result was set to 0.1, and the weighted average of the losses of the estimation result and the reconstruction result was set as the loss function. In this verification example (α=0.9, β=0.1), the classification accuracy was 89.43% (percent). The classification accuracy of the first comparative example was 85.53%. The classification accuracy of the second comparative example was 89.06%. That is, according to this verification example, it was possible to obtain the classification accuracy almost equal to that of the second comparative example while the amount of data used for estimation is the same as that of the first comparative example.

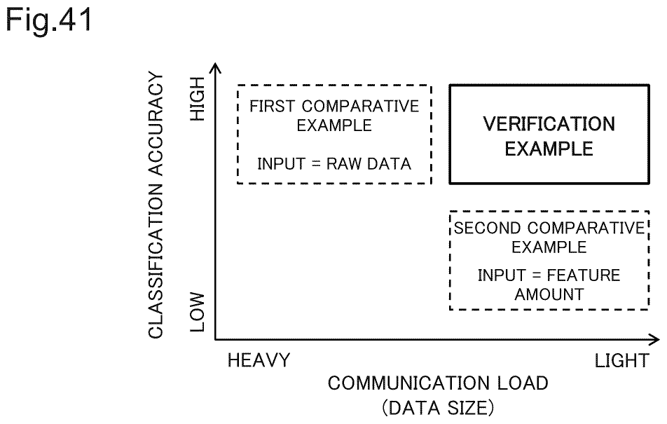

FIG. 41 is a diagram for comparing a communication load (data size) and classification accuracy between the present verification example and the first and second comparative examples. The communication load of this verification example is as light as that of the first comparative example estimated using the feature amount. The classification accuracy of this verification example is as high as that of the second comparative example estimated using raw data. That is, according to this verification example, high classification accuracy comparable to that of the second comparative example estimated using raw data can be achieved while the communication load is as light as that of the first comparative example estimated using the feature amount.

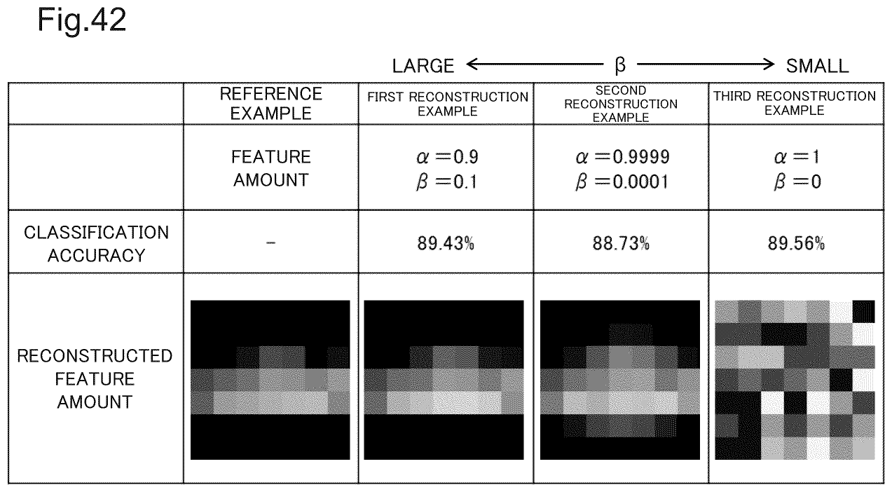

Next, in this verification example, an example in which the reconstruction result (reconstructed feature amount) by the reconstruction model is verified with the weight α of the estimation result and the weight 3 of the reconstruction result changed will be described. FIG. 42 is a conceptual diagram for describing a change in the reconstructed feature amount according to the weight α of the estimation result and the weight 3 of the reconstruction result. FIG. 42 illustrates an image of 7×7 pixels, but does not accurately represent an experiment result but conceptually represents the experiment result. FIG. 42 also illustrates a feature amount (reference example) calculated using the raw data. The feature amount of the reference example is designed based on knowledge.

In the first reconstruction example (α=0.9, β=0.1), the ratio of the weight β of the reconstruction result is large (10%). The classification accuracy of the estimation result in response to an input of the code to the estimation model constructed under the condition of the first reconstruction example was 89.43%. It is possible to intuitively grasp that the characteristic of the feature amount of the reference example remains in the reconstructed feature amount of the first reconstruction example.

In the second reconstruction example (α=0.9999, β=0.0001), the ratio of the weight β of the reconstruction result is smaller (0.01%) than that in the first reconstruction example. The classification accuracy of the estimation result in response to an input of the code to the estimation model constructed under the condition of the second reconstruction example was 88.73%. It is possible to intuitively grasp that the characteristic of the feature amount of the reference example remain also in the reconstructed feature amount of the second reconstruction example, but there are many aspects different from those of the reference example as compared with the first reconstruction example.

In the third reconstruction example (α=1, β=0), the weight β of the reconstruction result is 0. That is, in the third reconstruction example, the reconstruction result (reconstructed feature amount) is not reflected in the model. The classification accuracy of the estimation result in response to an input of the code to the code in the estimation model constructed under the condition of the third reconstruction example was 89.56%. It is not possible to intuitively grasp that the characteristic of the feature amounts of the reference example remain in the reconstructed feature amount of the third reconstruction example.

Since the feature amount of the reference example is designed based on knowledge, the feature amount includes a characteristic that can be intuitively grasped. According to the first to third reconstruction examples, by increasing the weight β of the reconstruction result, the reconstructed feature amount closer to that in the reference example is reconstructed from the code. That is, in this verification example, the code sufficiently includes information related to the knowledge. On the other hand, when the weight β of the reconstruction result is reduced, the constraint of the knowledge is weakened, and the feature amount is hardly reconstructed from the code. For example, in a case where the reliability of the feature amount is low, the performance may increase in practical use when the value of the weight β of the reconstruction result is reduced to weaken the constraint of the knowledge, and the code includes more information about the data starting point.

For example, in the training stage of the model, the reconstructed feature amount reconstructed using the code calculated from the raw data may be displayed on the screen. When the reconstructed feature amount is displayed on the screen, the feature included in the original code of the reconstructed feature amount is visualized, so that it is possible to intuitively grasp the quality of the model in the training stage. For example, as illustrated in FIG. 42, when the feature amounts and the reconstructed feature amounts are disposed and displayed on the screen, it is easy to more intuitively grasp the feature included in the original code of the reconstructed feature amount.

For example, by calculating the similarity between the feature amount and the reconstructed feature amount, the characteristic included in the original code of the reconstructed feature amount can be evaluated numerically. For example, when a threshold value is set for the similarity between the feature amount and the reconstructed feature amount, the characteristic included in the original code of the reconstructed feature amount can be numerically evaluated according to the relationship between the similarity and the threshold value. For example, the similarity between the feature amount and the reconstructed feature amount may be displayed on the screen.

### (Hardware)

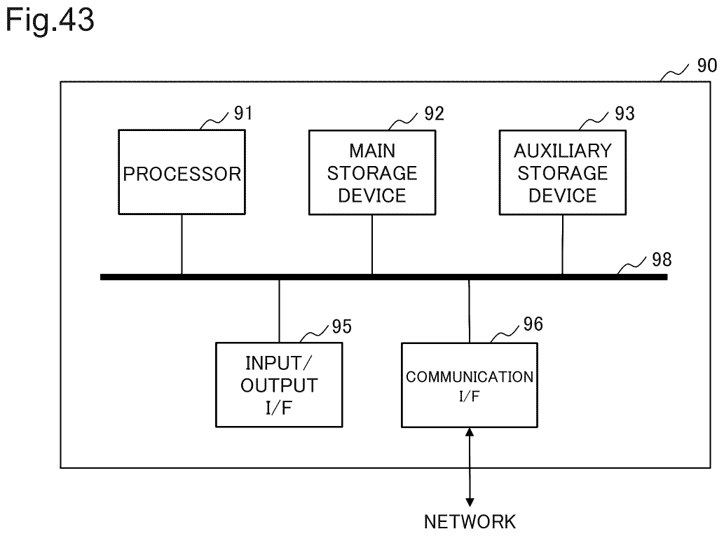

A hardware configuration for executing processing of the training device and the estimation device according to each example embodiment of the present disclosure will be described using an information processing device 90 of FIG. 43 as an example. The information processing device 90 in FIG. 43 is a configuration example for executing processing of the training device and the estimation device of each example embodiment, and does not limit the scope of the present disclosure.

As illustrated in FIG. 43, the information processing device 90 includes a processor 91, a main storage device 92, an auxiliary storage device 93, an input/output interface 95, and a communication interface 96. In FIG. 43 the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present embodiment, a software program installed in the information processing device 90 may be used. The processor 91 executes processing by the training device and the estimation device according to the present embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). A nonvolatile memory such as a magnetoresistive random access memory (MRAM) may be configured and added as the main storage device 92.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input of information and settings. In a case where the touch panel is used as the input device, the display screen of the display device may also serve as the interface of the input device. Data communication between the processor 91 and the input device may be mediated by the input/output interface 95.

The information processing device 90 may be provided with a display device that displays information. In a case where a display device is provided, the information processing device 90 preferably includes a display control device (not illustrated) that controls display of the display device. The display device may be connected to the information processing device 90 via the input/output interface 95.

The information processing device 90 may be provided with a drive device. The drive device mediates reading of data and a program from the recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for enabling the training device and the estimation device according to each example embodiment of the present invention. The hardware configuration of FIG. 43 is an example of a hardware configuration for executing an arithmetic process of the training device and the estimation device according to each example embodiment, and does not limit the scope of the present invention. A program for causing a computer to execute processing related to the training device and the estimation device according to each example embodiment is also included in the scope of the present invention. A program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium. In a case where the program executed by the processor is recorded in the recording medium, the recording medium corresponds to a program recording medium.

The components of the training device and the estimation device of each example embodiment may be combined as desired. The components of the training device and the estimation device of each example embodiment may be achieved by software or may be achieved by a circuit.

While the present invention is described with reference to example embodiments thereof, the present invention is not limited to these example embodiments. Various modifications that can be understood by those of ordinary skill in the art can be made to the configuration and details of the present invention within the scope of the present invention.

Some or all of the above example embodiments may be described as the following Supplementary Notes, but are not limited to the following.

### (Supplementary Note 1)

A training device including
an acquisition unit that acquires a data set of raw data and correct answer data,
a feature amount calculation unit that calculates a feature amount using the raw data,
a model construction unit that constructs an encoding model that outputs a code related to the feature amount in response to an input of the raw data and an estimation model that outputs an estimation result related to the raw data in response to an input of the code, and
a training processing unit that trains the encoding model and the estimation model in such a way that the estimation result matches the correct answer data based on a relationship between the code and the feature amount.

### (Supplementary Note 2)

The training device according to Supplementary Note 1, wherein
the model construction unit
constructs the estimation model using the code output from the encoding model in response to the input of the raw data and the feature amount calculated using the raw data.

### (Supplementary Note 3)

The training device according to Supplementary Note 1 or 2, wherein
the model construction unit
constructs a reconstruction model that outputs a reconstructed feature amount related to the original feature amount of the code in response to the input of the code, and wherein
the training processing unit
trains the encoding model and the reconstruction model in such a way that the reconstructed feature amount matches the feature amount, and trains the encoding model and the estimation model in such a way that the estimation result matches the correct answer data based on the relationship between the code and the feature amount.

### (Supplementary Note 4)

The training device according to Supplementary Note 3, wherein the model construction unit
constructs the estimation model using the reconstructed feature amount output from the reconstruction model in response to the input of the code and the code.
   (Supplementary Note 5) The training device according to any one of Supplementary Notes 1 to 4, wherein the training processing unit trains the estimation model in such a way that a mutual information amount of the code output from the encoding model in response to the input of the raw data and the feature amount calculated using the raw data is reduced.

### (Supplementary Note 6)

The training device according to Supplementary Note 1 or 2, wherein
the model construction unit
constructs a first pre-training model that outputs a first conversion value related to the feature amount in response to the input of the raw data, and wherein
the training processing unit
trains the first pre-training model in such a way that the first conversion value matches the feature amount,
sets a model parameter of the first pre-training model after training as an initial value of the encoding model, and
trains the encoding model and the estimation model in such a way that the estimation result matches the correct answer data.

### (Supplementary Note 7)

The training device according to Supplementary Note 6, wherein
the model construction unit
constructs a second pre-training model that outputs a second conversion value related to the raw data in response to an input of the feature amount calculated using the raw data, and wherein
the training processing unit
trains the second pre-training model in such a way that the second conversion value matches the estimation result,
sets a model parameter of the second pre-training model after training as an initial value of the estimation model, and
trains the encoding model and the estimation model in such a way that the estimation result matches the correct answer data.

### (Supplementary Note 8)

An estimation system including
an estimation device in which an encoding model and an estimation model constructed by the training device according to any one of Supplementary Notes 1 to 7 are implemented,
the system including
a measurement device that includes at least one measurement instrument and the encoding model, inputs raw data measured by the measurement instrument to the encoding model, and transmits a code output from the encoding model in response to an input of the raw data, and
the estimation device that includes the estimation model, receives the code transmitted from the measurement device, inputs the received code to the estimation model, and outputs an estimation result output from the estimation model in response to an input of the code.

### (Supplementary Note 9)

The estimation system according to Supplementary Note 8, wherein
the measurement device
calculates a feature amount using the raw data, and
transmits the code output from the encoding model in response to the input of the raw data and the feature amount calculated using the raw data to the estimation device, and wherein
the estimation device
receives the code and the feature amount transmitted from the measurement device,
inputs the received code and the received feature amount to the estimation model, and
outputs the estimation result output from the estimation model in response to inputs of the code and the feature amount.

### (Supplementary Note 10)

The estimation system according to Supplementary Note 8 or 9, wherein
the estimation device
includes a reconstruction model that outputs a reconstructed feature amount related to the original feature amount of the code in response to the input of the code,
inputs, to the estimation model, a reconstructed feature amount output from the reconstruction model in response to the input of the code, and
outputs the estimation result output from the estimation model in response to an input of the reconstructed feature amount.

### (Supplementary Note 11)

The estimation system according to any one of Supplementary Notes 8 to 10, wherein
the measurement device
is worn by a user, measures sensor data related to a motion of the user, and transmits the code output from the encoding model to the estimation device in response to an input of the measured sensor data, and wherein
the estimation device
receives the code transmitted from the measurement device and
transmits information related to the estimation result to a mobile terminal having a display unit with which the estimation result can be visually recognizable by the user.

### (Supplementary Note 12)

A training method executed by a computer, the method including
acquiring a data set of raw data and correct answer data,
calculating a feature amount using the raw data,
constructing an encoding model that outputs a code related to the feature amount in response to an input of the raw data and an estimation model that outputs an estimation result related to the raw data in response to an input of the code, and
training the encoding model and the estimation model in such a way that the estimation result matches the correct answer data based on a relationship between the code and the feature amount.

### (Supplementary Note 13)

A program for causing a computer to execute the steps of
acquiring a data set of raw data and correct answer data,
calculating a feature amount using the raw data,
constructing an encoding model that outputs a code related to the feature amount in response to an input of the raw data and an estimation model that outputs an estimation result related to the raw data in response to an input of the code, and
training the encoding model and the estimation model in such a way that the estimation result matches the correct answer data based on a relationship between the code and the feature amount.

### REFERENCE SIGNS LIST

10, 20, 30, 40 training device
11, 21, 31, 41 acquisition unit
12, 22, 32, 42 feature amount calculation unit
13, 23, 33, 43 model construction unit
15, 25, 35, 45 training processing unit
50, 60, 70 estimation system
51, 61, 71 measurement device
53, 63, 73 estimation device
131, 231, 331 encoding unit
133 reconstruction unit
135, 235, 335 estimation unit
151, 251, 351 encoding model
153 reconstruction model
155, 255, 355 estimation model
337 first pre-training unit
338 second pre-training unit
357 first pre-trained model
358 second pre-trained model
511, 611, 711 acceleration sensor
512, 612, 712 angular velocity sensor
513, 613, 713 control unit
515, 615, 715 encoding unit
517, 617, 717 transmission unit
531, 631, 731 reception unit
535, 635, 735 estimation unit
537, 637, 737 output unit
551, 651, 751 encoding model
555, 655, 755 estimation model
616 feature amount extraction unit
733 reconstruction unit
753 reconstruction model

What is claimed is:

1. A training device comprising:
a first memory storing instructions; and
a first processor connected to the first memory and configured to execute the instructions to:
acquire a data set of raw data and correct answer data;
calculate a feature amount using the raw data;
construct an encoding model that outputs a code related to the feature amount in response to an input of the raw data and an estimation model that outputs an estimation result related to the raw data in response to an input of the code; and
train the encoding model and the estimation model in such a way that the estimation result matches the correct answer data based on a relationship between the code and the feature amount.

2. The training device according to claim 1, wherein
the first processor is configured to execute the instructions to
construct the estimation model using the code output from the encoding model in response to the input of the raw data and the feature amount calculated using the raw data.

3. The training device according to claim 1, wherein
the first processor is configured to execute the instructions to
construct a reconstruction model that outputs a reconstructed feature amount related to the original feature amount of the code in response to the input of the code, and wherein
the first processor is configured to execute the instructions to
train the encoding model and the reconstruction model in such a way that the reconstructed feature amount matches the feature amount, and
train the encoding model and the estimation model in such a way that the estimation result matches the correct answer data based on the relationship between the code and the feature amount.

4. The training device according to claim 3, wherein
the first processor is configured to execute the instructions to
construct the estimation model using the reconstructed feature amount output from the reconstruction model in response to the input of the code and the code.

5. The training device according to claim 1, wherein
the first processor is configured to execute the instructions to
train the estimation model in such a way that a mutual information amount of the code output from the encoding model in response to the input of the raw data and the feature amount calculated using the raw data is reduced.

6. The training device according to claim 1, wherein
the first processor is configured to execute the instructions to
construct a first pre-training model that outputs a first conversion value related to the feature amount in response to the input of the raw data,
train the first pre-training model in such a way that the first conversion value matches the feature amount,
set a model parameter of the first pre-training model after training as an initial value of the encoding model, and
train the encoding model and the estimation model in such a way that the estimation result matches the correct answer data.

7. The training device according to claim 6, wherein
the first processor is configured to execute the instructions to
construct a second pre-training model that outputs a second conversion value related to the raw data in response to an input of the feature amount calculated using the raw data, and wherein
train the second pre-training model in such a way that the second conversion value matches the estimation result,
set a model parameter of the second pre-training model after training as an initial value of the estimation model, and
train the encoding model and the estimation model in such a way that the estimation result matches the correct answer data.

8. An estimation system comprising
an estimation device in which an encoding model and an estimation model constructed by the training device according to claim 1 are implemented,
the system comprising:
a measurement device that includes
at least one measurement instrument and the encoding model,
a second memory storing instructions, and
a second processor connected to the second memory and configured to execute the instructions to
input raw data measured by the measurement instrument to the encoding model, and
transmit a code output from the encoding model in response to an input of the raw data, and
the estimation device that includes the estimation model,
a third memory storing instructions, and
a third processor connected to the third memory and configured to execute the instructions to
receive the code transmitted from the measurement device,
input the received code to the estimation model, and
output an estimation result output from the estimation model in response to an input of the code.

9. The estimation system according to claim 8, wherein
the second processor of the measurement device is configured to execute the instructions to
calculate a feature amount using the raw data, and
transmit the code output from the encoding model in response to the input of the raw data and the feature amount calculated using the raw data to the estimation device, and wherein
the third processor of the estimation device is configured to execute the instructions to
receive the code and the feature amount transmitted from the measurement device,
input the received code and the received feature amount to the estimation model, and
output the estimation result output from the estimation model in response to inputs of the code and the feature amount.

10. The estimation system according to claim 8, wherein
the estimation device includes a reconstruction model that outputs a reconstructed feature amount related to the original feature amount of the code in response to the input of the code, and wherein
the third processor of the estimation device is configured to execute the instructions to
input, to the estimation model, a reconstructed feature amount output from the reconstruction model in response to the input of the code, and
output the estimation result output from the estimation model in response to an input of the reconstructed feature amount.

11. The estimation system according to claim 8, wherein
the measurement device is worn by a user, wherein
the second processor of the measurement device is configured to execute the instructions to
measure sensor data related to a motion of the user, and
transmit the code output from the encoding model to the estimation device in response to an input of the measured sensor data, and wherein
the third processor of the estimation device is configured to execute the instructions to
receive the code transmitted from the measurement device and
transmit information related to the estimation result to a mobile terminal having a display means with which the estimation result can be visually recognizable by the user.

12. A training method executed by a computer, the method comprising:
acquiring a data set of raw data and correct answer data;
calculating a feature amount using the raw data;
constructing an encoding model that outputs a code related to the feature amount in response to an input of the raw data and an estimation model that outputs an estimation result related to the raw data in response to an input of the code; and
training the encoding model and the estimation model in such a way that the estimation result matches the correct answer data based on a relationship between the code and the feature amount.

13. A non-transitory recording medium storing a program for causing a computer to execute:
a process of acquiring a data set of raw data and correct answer data;
a process of calculating a feature amount using the raw data;
a process of constructing an encoding model that outputs a code related to the feature amount in response to an input of the raw data and an estimation model that outputs an estimation result related to the raw data in response to an input of the code; and
a process of training the encoding model and the estimation model in such a way that the estimation result matches the correct answer data based on a relationship between the code and the feature amount.
